(19) United States
(12) Patent Application Publication
(10) Pub. No.: US 2025/0272500 A1
(43) Pub. Date: Aug. 28, 2025

(54) Systems And Methods For Generative Language Model Database System Integration Architecture

(71) Applicant: Salesforce, Inc., San Francisco, CA (US)

(72) Inventors: Atul Chandrakant KSHIRSAGAR, San Ramon, CA (US); Prithvi Krishnan PADMANABHAN, San Ramon, CA (US); Adheip VARADARAJAN, Orinda, CA (US); Supreeth Srinivasa MURTHY, San Ramon, CA (US); Nishant PENTAPALLI, Groton, MA (US); Rajasekar ELANGO, Tampa, FL (US); Bharat SURI, Santa Clara, CA (US)

(73) Assignee: Salesforce, Inc., San Francisco, CA (US)

(21) Appl. No.: 18/750,469

(22) Filed: Jun. 21, 2024

Related U.S. Application Data
(60) Provisional application No. 63/558,557, filed on Feb. 27, 2024.
(60) Provisional application No. 63/558,580, filed on Feb. 27, 2024.
(60) Provisional application No. 63/558,641, filed on Feb. 27, 2024.
(60) Provisional application No. 63/558,653, filed on Feb. 28, 2024.

(51) Int. Cl. G06F 40/35

(52) U.S. Cl. CPC G06F 40/35

(57) ABSTRACT

A computing services environment may include a database system may store database records for client organizations accessing computing services including a conversational chat assistant. The computing services environment may also include an application server receiving natural language user input for the conversational chat assistant and a generative language model interface providing access to one or more generative language models. The computing services environment may also include an orchestration and planning service configured to analyze the natural language user input via a generative language model of the one or more generative language models to identify a plurality of actions to execute via the computing services environment to fulfill an intent expressed in the natural language user input. The computing services environment may be configured to execute the plurality of actions to determine a natural language response message.

### CROSS-REFERENCE TO RELATED APPLICATIONS

This application claims the benefit under 35 U.S.C. § 119 (e) of U.S. Provisional Patent Application 63/558,557 (Attorney Docket No. SFDCP224P) by Padmanabhan, titled “GENERATIVE LANGUAGE MODEL DATABASE SYSTEM INTEGRATION ARCHITECTURE”, filed on Feb. 27, 2024, and to U.S. Provisional Patent Application 63/558,580 (Attorney Docket No. SFDCP225P) by Padmanabhan, titled “GENERATIVE LANGUAGE MODEL DATABASE SYSTEM INTEGRATION INTERFACE CONFIGURATION”, filed on Feb. 27, 2024, and to U.S. Provisional Patent Application 63/558,641 (Attorney Docket No. SFDCP226P) by Padmanabhan, titled “GENERATIVE LANGUAGE MODEL DATABASE SYSTEM ACTION CONFIGURATION AND EXECUTION”, filed on Feb. 27, 2024, and to U.S. Provisional Patent Application 63/558,653 (Attorney Docket No. SFDCP227P) by Padmanabhan, titled “GENERATIVE LANGUAGE MODEL DATABASE SYSTEM ACTION CUSTOMIZATION AND EXECUTION”, filed on Feb. 28, 2024, all of which are incorporated herein by reference in their entirety and for all purposes.

### FIELD OF TECHNOLOGY

This patent application relates generally to database systems, and more specifically to the integration of database systems with generative language models.

### BACKGROUND

“Cloud computing” services provide shared resources, applications, and information to computers and other devices upon request. In cloud computing environments, services can be provided via a computing services environment by one or more servers accessible over the Internet rather than installing software locally on in-house computer systems. Users can interact with cloud computing services to undertake a wide range of tasks.

More recently, generative language models have been developed that allow the generation of novel text. However, systems for managing interactions between cloud computing environments and generative language models are limited. Accordingly, improved systems and methods are needed in order to incorporate generative language models into the cloud-based infrastructure commonly employed for accessing computing services.

### BRIEF DESCRIPTION OF THE DRAWINGS

The included drawings are for illustrative purposes and serve only to provide examples of possible structures and operations for the disclosed inventive systems, apparatus, methods, and computer program products for generative language model database system integration. These drawings in no way limit any changes in form and detail that may be made by one skilled in the art without departing from the spirit and scope of the disclosed implementations.

FIG. 1 illustrates a computing services environment that includes a unified metadata framework for specifying aspects of the conversational chat system.

FIG. 2 illustrates an overview of the conversational chat system architecture, configured in accordance with one or more embodiments.

FIG. 3 illustrates a trust model for the conversational chat system, configured in accordance with one or more embodiments.

FIG. 4 illustrates an example of a flow, performed in accordance with one or more embodiments.

FIG. 5 illustrates a conversational chat assistant execution method, performed in accordance with one or more embodiments.

FIG. 6 illustrates a method for determining a plan via a generative language model, performed in accordance with one or more embodiments.

FIG. 7 illustrates a metadata diagram showing relationships between elements for configuring actions, provided in accordance with one or more embodiments.

FIG. 8 illustrates a method for generating novel text, performed in accordance with one or more embodiments.

FIG. 9 shows a block diagram of an example of an environment that includes an on-demand database service configured in accordance with some implementations.

FIG. 10A shows a system diagram of an example of architectural components of an on-demand database service environment, configured in accordance with some implementations.

FIG. 10B shows a system diagram further illustrating an example of architectural components of an on-demand database service environment, in accordance with some implementations.

FIG. 11 illustrates one example of a computing device, configured in accordance with one or more embodiments.

FIG. 12 illustrates a method for configuring a conversational chat assistant, performed in accordance with one or more embodiments.

FIG. 13 illustrates a metadata diagram showing relationships between elements for configuring actions, provided in accordance with one or more embodiments.

FIG. 14 illustrates an example of markup code corresponding to actions, configured in accordance with one or more embodiments.

FIG. 15 and FIG. 16 illustrate examples of user interfaces for configuring and testing various elements of a conversational chat assistant, generated in accordance with one or more embodiments.

FIG. 17 illustrates a method for configuring a next action for a conversational chat assistant, performed in accordance with one or more embodiments.

FIG. 18 illustrates a method for updating a conversational chat interface, performed in accordance with one or more embodiments.

FIG. 19 illustrates a user interface provided in the context of a communication session with a conversational chat assistant, generated in accordance with one or more embodiments.

FIG. 20 illustrates a conversational chat interface provided in the context of a communication session with a conversational chat assistant, generated in accordance with one or more embodiments.

FIG. 21 illustrates a method for configuring output for a conversational chat assistant, performed in accordance with one or more embodiments.

FIG. 22 illustrates a method for outputting a natural language response generated by a conversational chat assistant, performed in accordance with one or more embodiments.

FIGS. 23A and 23B illustrate configurable user interfaces, provided in accordance with one or more embodiments.

FIG. 24 illustrates a method for configuring a topic, performed in accordance with one or more embodiments.

### DETAILED DESCRIPTION

### Introduction

Techniques and mechanisms described herein provide for a computing services environment equipped with a conversational chat system capable of providing customized conversational chat assistants. According to various embodiments, a conversational chat assistant may be configured to perform operations such as receiving text-based user input, retrieving information from a database system, storing information to a database system, defining and executing workflows and actions within a computing services environment, interacting with one or more generative language models, determining text-based output, and facilitating communication with a client machine via any of various communication channels.

According to various embodiments, a conversational chat assistant configured in the context of the conversational chat system may be used in the context of workflows for business tasks such as sales, service, marketing, and commerce to complete tasks using intelligent actions. The conversational chat assistant may be equipped with a built-in trust layer to generate natural language responses grounded in data, such as customer relations management data, data external to a computing services environment, and/or other types of data. The conversational chat assistant may be customized with actions that employ user-specified and/or standardized flows, code, prompts, and/or application procedure interfaces.

In some embodiments, users may interact with a conversational chat assistant using natural language provided via a user interface. Alternatively, or additionally, the conversational chat assistant may dynamically generate action buttons for performing complex actions with a click. In some configurations, the conversational chat assistant may be integrated natively into existing applications provided via a computing services environment used to access web applications such as customer relations management applications.

In some embodiments, the conversational chat system may provide multi-channel communication functionality for a conversational chat assistant, for instance providing access to communication via tools such as Facebook Messenger, WhatsApp, SMS, mobile, web, WeChat, Slack, Microsoft Teams, custom communication channels, and/or other communication channels.

In some embodiments, a computer services environment may provide access to web applications and/or applications integrated into other user interfaces such as those associated with a communication channel, browser plugin, native mobile application, or other interface. In this way, a customer organization may access a conversational chat assistant configured via the conversational chat system through any of a variety of channels. Moreover, the conversational chat system may support a common onboarding process that supports a set of common best practices when configuring a new (e.g., organization-specific) conversational chat assistant. Additionally, both agents and customers of the customer organization may be provided with a unified platform for accessing the conversational chat assistant.

### Conversational Chat Architecture

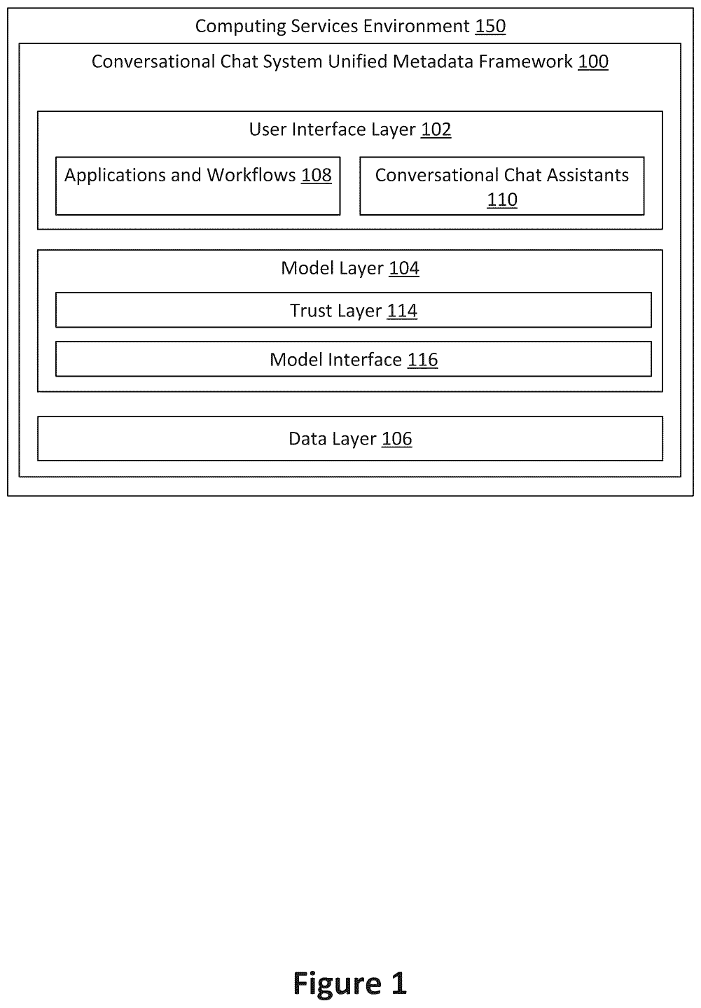

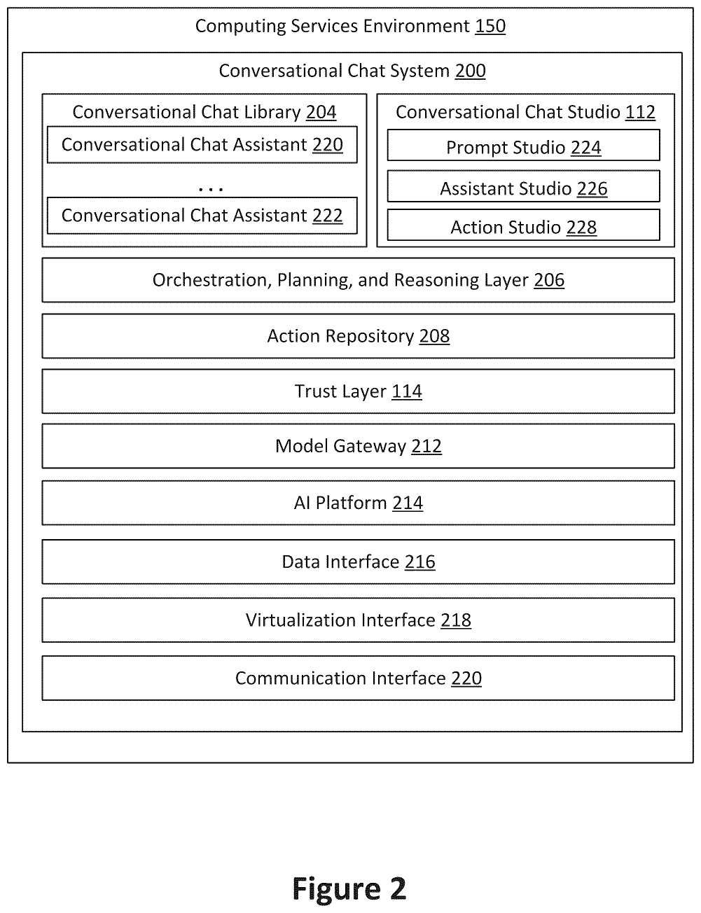

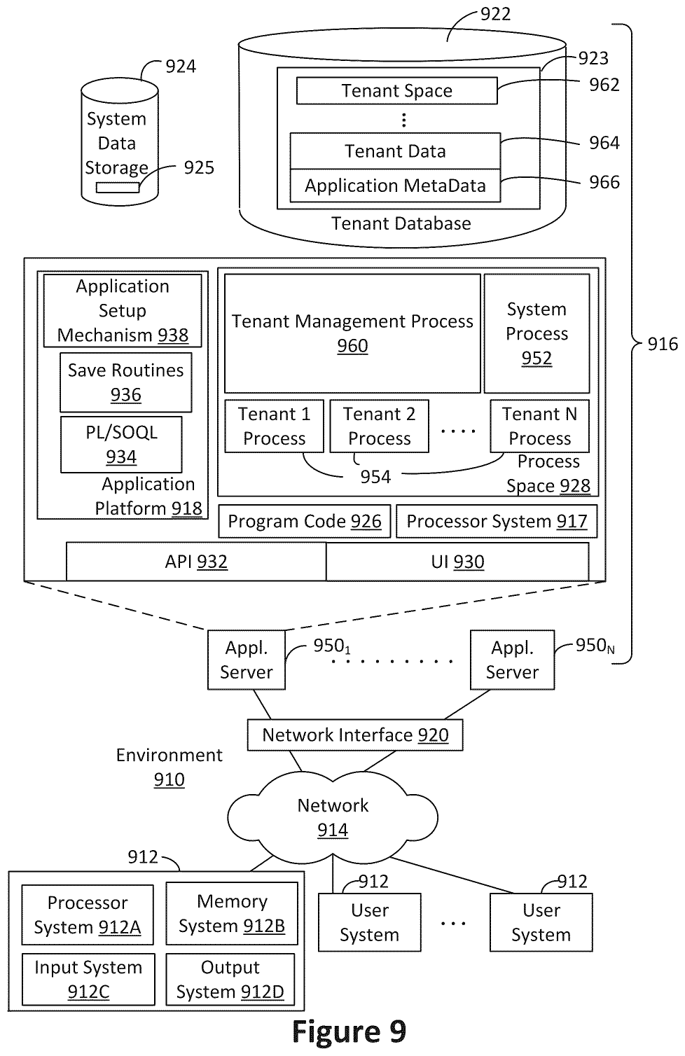

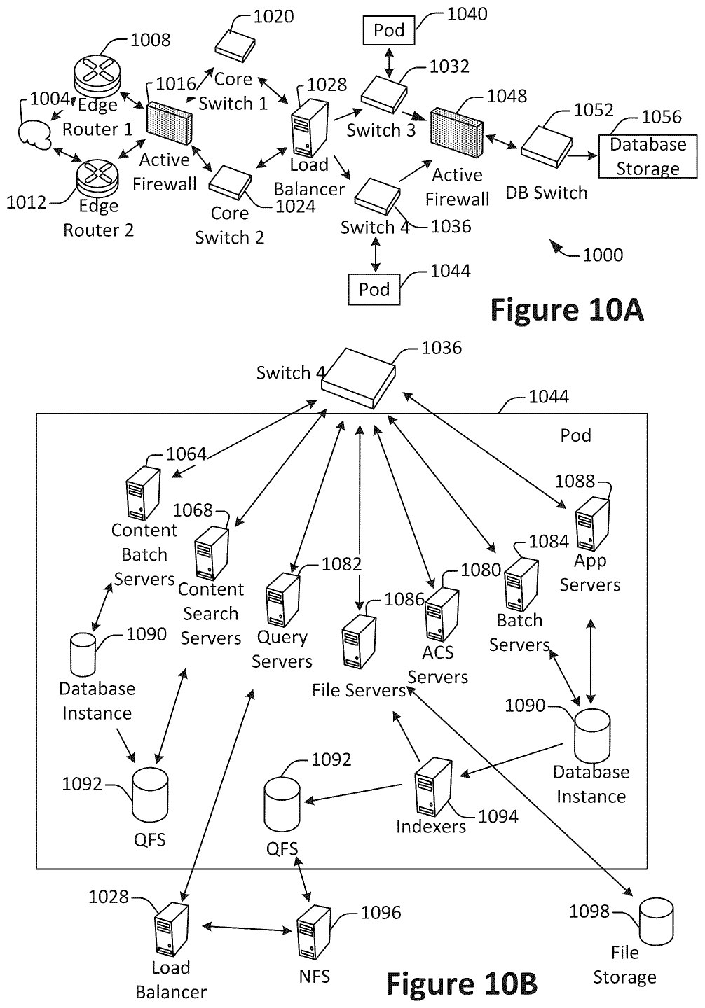

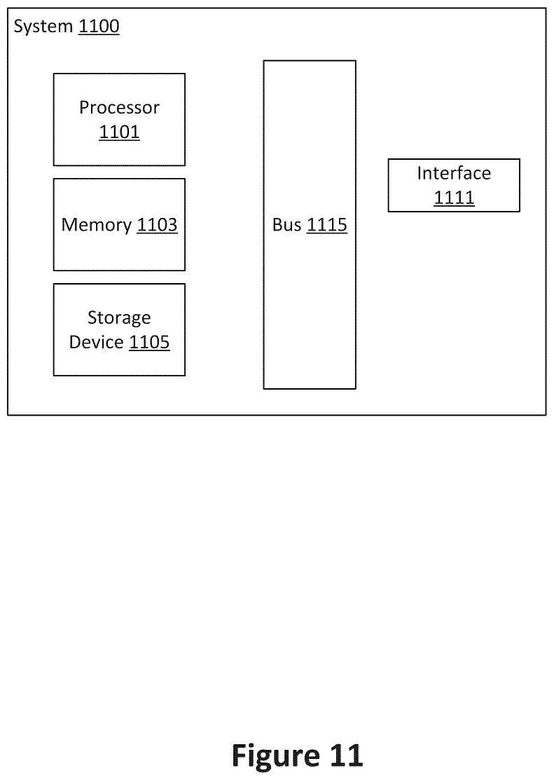

FIG. 1 illustrates a computing services environment 150 that includes a unified metadata framework 100 for specifying aspects of the conversational chat system. According to various embodiments, the computing services environment 150 may include various elements and components other than the unified metadata framework 100. Such elements are discussed throughout the application as filed, for instance with respect to FIG. 2, FIG. 9, FIG. 10A, and FIG. 10B. However, for the purpose of illustration, FIG. 1 focuses on the unified metadata framework 100.

According to various embodiments, the unified metadata framework 100 may facilitate interaction between various elements of the computing services environment 150 and a conversational chat system. The unified metadata framework 100 includes a user interface layer 102, a model layer 104, and a data layer 106.

In some embodiments, the user interface layer 102 facilitates the specification of various applications and workflows 108. Such applications and workflows may include operations performed within and/or outside of the computing services environment 150. For example, applications and workflows may be specific to types of services provided via the computing services environment 150, such as sales, service, marketing, commerce, data analysis, and the like. As another example, applications and workflows may include domain-specific operations, such as those specific to healthcare, finance, or other industries.

In some embodiments, the user interface layer 102 facilitates the specification of conversational chat assistants 110. For example, the computing service environment 150 may provide one or more standard conversational chat assistants that may be accessed through user interfaces provided via the computing services environment 150 or via other communication channels such as email, SMS, or external chat services. As another example, a conversational chat assistant may be customized by, for instance, an organization accessing computing services via the computing services environment 150.

In some embodiments, the conversational chat assistant may perform operations such as receiving user input, executing one or more applications, workflows, actions, or operations within the computing services environment 150, and/or interacting with a database system, generative language model, other artificial intelligence models, and/or other system accessible via the computing services environment 150.

According to various embodiments, the model layer 104 provides for secure interaction with one or more artificial intelligence models. The model layer 104 includes a a trust layer 114, and a model interface 116.

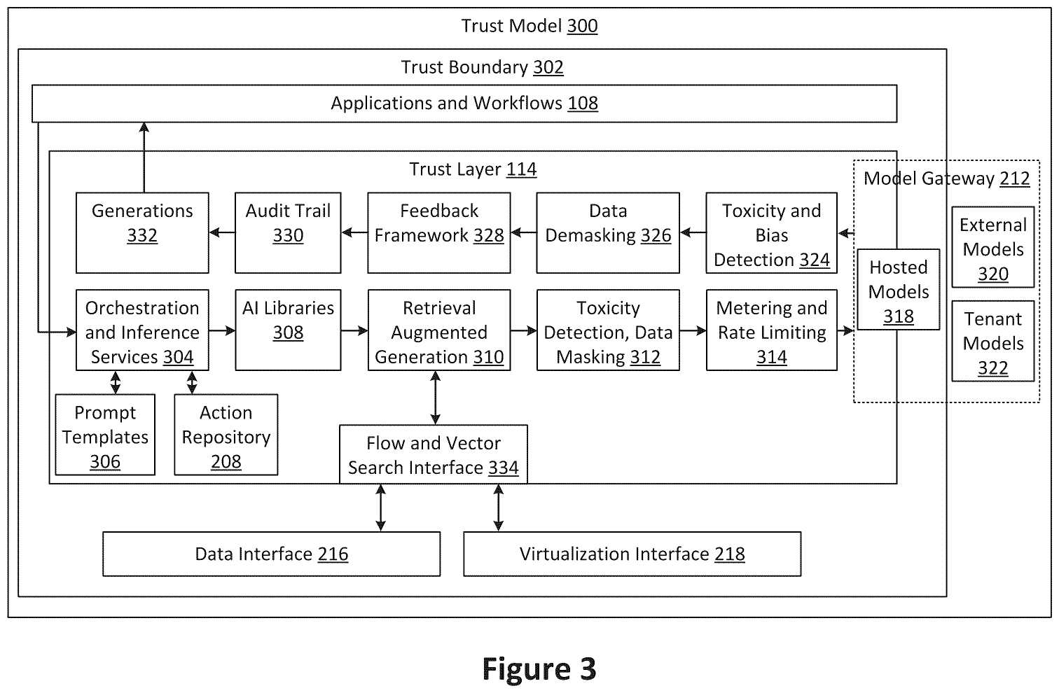

According to various embodiments, the trust layer 114 is configured to perform operations such as masking personally identifying information, securely retrieving data, detecting toxic language generated by a generative language model, and defending prompt completions against injection attacks and other attacks. Thus, the trust layer may provide additional protections for various actions performed in the context of various applications, workflows, and conversational chat assistants. Additional details related to the trust layer are discussed throughout the application, for instance with respect to FIG. 3.

In some implementations, the data layer 106 provides access to data sources, which may be located inside or outside of the computing services environment 150. Examples of such data sources may include, but are not limited to: structured data sources, unstructured data sources, data lakes, vector databases, relational databases, unified user profiles, data-based actions, data warehouses, and data lakehouses.

FIG. 2 illustrates an overview of the conversational chat system architecture 200, configured in accordance with one or more embodiments. The conversational chat system architecture 200 includes a conversational chat library 204, a conversational chat studio 112, an orchestration, planning, and reasoning layer 206, an action repository 208, the trust layer 114, a model gateway 212, an AI platform 214, a data interface 216, a virtualization interface 218, and a communication interface 220. FIG. 2 is provided as a high-level illustration of the functioning of various components within the conversational chat system architecture 200. Additional details regarding the operation of these various components are provided throughout the application.

In some embodiments, a conversational chat assistant may be used to perform one or more tasks within the computing services environment 150. For example, a conversational chat assistant may interactively converse with a user in natural language. As another example, a conversational chat assistant may interact with one or more artificial intelligence models, including one or more generative language models. As yet another example, a conversational chat assistant may retrieve information from a database system, store information to a database system, transmit one or more messages, and/or take other actions within the computing services environment 150.

In some embodiments, the conversational chat studio 112 allows for the construction and customization of various aspects of the conversational chat system. The conversational chat studio 112 may include elements such as a user interface, metadata information, monitoring, governance, and/or search tools for building conversational chat assistants 110. For example, the conversational chat studio 112 may provide support for constructing one or more prompts, actions, applications, workflows, or the like.

The conversational chat studio 112 includes a prompt studio 224, an assistant studio 226, and an action studio 228. According to various embodiments, the conversational chat studio 112 provides functionality for the configuration of assistants, actions, and prompts to support conversational chat system customized for a customer organization. For example, a user may build, test, and integrate prompts, actions, and/or conversational chat assistants into one or more applications provided by or interoperating with the computing services environment 150 to support the performance of various tasks for an organization.

Conversational chat assistants 220 through 222 may be stored in the conversational chat library 204. One or more conversational chat assistants may be configured in a standardized format for use by various organizations and individuals. Additionally, one or more conversational chat assistants may be customized for particular industries, organizations, individuals, applications, and/or other contexts.

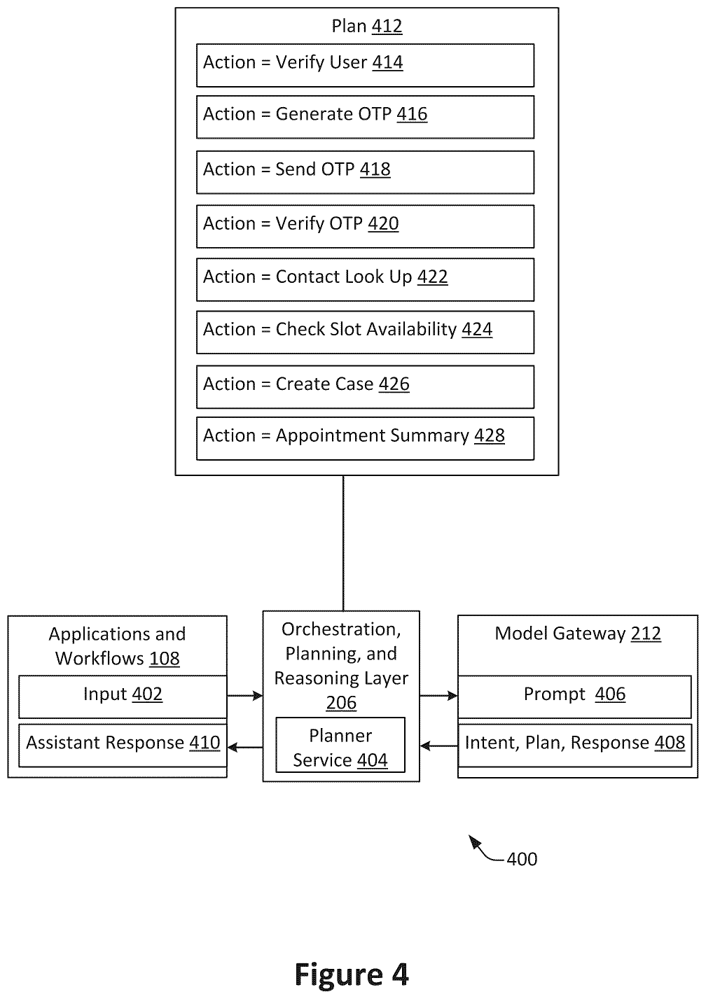

At 206, an orchestration, planning, and reasoning layer provides for the execution of a conversational chat assistant to interpret, decompose, and implement actions based on user inputs. For example, a user instruction such as “draft an email summarizing this record” may be analyzed to identify an overall intent. The user instruction may also be decomposed into actions such as “summarize a record” and “draft an email using the summary”. The decomposition and overall intent may be used to orchestrate and execute a plan, which may involve identifying the focal record, determining and completing one or more prompts to determine the summary, and determining and completing one or more prompts to draft an email using the summary. Additional details regarding the formulation and execution of such a plan are discussed throughout the application, for instance with respect to FIG. 4.

According to various embodiments, the action repository 208 may include one or more actions that are preconfigured to perform tasks within the computing services environment 150. For instance, an action repository may include actions such as “summarize a record” or “draft an email.” A conversational chat assistant may identify and execute such actions in order to implement a user's intent.

In some embodiments, one or more of the actions may be specific to a particular domain. For instance, one or more actions in the health or finance domains may include particular constraints, such as instructions provided to a generative language model, to provide for compliance with relevant laws and regulations.

In some embodiments, one or more of the actions may be configurable and/or user-defined. For instance, a user associated with an organization accessing computing services via the computing services environment 150 may provide code and/or other action definition information specifying an action to be performed. The defined action may then be incorporated into an orchestration or workflow.

The model gateway 212 provides access to one or more generative language models or other artificial intelligence models. In some embodiments, a conversational chat assistant may be supported by a range of different generative language models. For example, a customer organization may be able to use standardized models provided by model providers such as Open AI, Microsoft Azure, Gemini, or the like. As another example, the model gateway 212 may also support customized models, for instance models customized and/or hosted by a customer organization. As yet another example, the model gateway 212 may provide access to models hosted by the computing service environment itself.

In some embodiments, the customer organization may configure a conversational chat assistant to employ different models for different aspects of a conversational chat assistant. For example, the customer organization may use one model (e.g., Gemini) for a function such as “summarize record”, and another model (e.g., Open AI) for a function such as “draft email”.

In some embodiments, the model gateway 212 may provide a feedback framework for receiving user feedback. The user feedback may be stored in the database and may be used for a variety of purposes, such as finetuning a conversational chat assistant and/or one or more of the underlying generative language models.

The AI platform 214 may provide support for generative language models hosted by the service provider of the computing services environment 150 and/or one or more partner or customer organizations. For example, the customer organization may provide their own LLM, such as a hosted LLM. As another example, the customer may employ a customer-tuned version of a standard model, such as the customer's version of a model provided by Azure or Gemini. As still another example, a conversational chat assistant may employ a standard generative language model hosted by the service provider of the computing services environment.

The data interface 216 provides access to one or more of a variety of data sources. According to various embodiments, a conversational chat assistant may access one or more data sources to support the conversational chat operations. For example, a conversational chat assistant may access third party data sources such as Google Cloud, Google BigQuery, Amazon S3, or Microsoft Azure. As another example, a conversational chat assistant may access one or more data sources from inside the computing services environment, such as customer relations management data. As still another example, a conversational chat assistant may access data from other sources, such as legacy systems, external apps, mobile sources, web sources, software development kids, and/or application procedure interfaces. Examples of data interfaces may include, but are not limited to: data lakehouses, real-time data services, zero-ETL data services, united profiles, data actions, data connectors, relational database systems, and any other interfaces for accessing structured, unstructured, or semi-structured data sources.

At 218, a virtualization platform provides for the ability to deploy one or more aspects of the platform provided via the computing services environment in one or more virtual environments. For example, data residency requirements may be enforced, ensuring that data resides in a particular location. As another example, communications may be encrypted end-to-end. As still another example, one or more regulatory requirements may be enforced.

The communication interface 220 facilitates communication with one or more client machines via any of various communication channels. For example, depending on the system configuration, a client machine may communicate with a conversational chat assistant via a web interface, a messaging application, email, voice, SMS messages, and/or any other suitable communication channel.

FIG. 3 illustrates a trust model 300 for the conversational chat system, configured in accordance with one or more embodiments. The trust model 300 includes a trust boundary 302. Inside the trust boundary 302 are the applications and workflows 108, the trust layer 114, the data interface 216, and the virtualization interface 218.

In some embodiments, the trust boundary 302 may separate internal from external services. Inside the trust boundary, at 206, a trust layer may provide for the execution of various trust related operations. Outside the trust boundary, one or more external services or models may operate in an untrusted zone or a zone of shared trust.

The trust layer 114 includes one or more orchestration and inference services 304, one or more artificial intelligence libraries 308, one or more retrieval augmented generation services 310, one or more inbound toxicity detection and/or data masking services 312, one or more metering and rate limiting services 314, one or more outbound toxicity and bias detection services 324, one or more data demasking services 326, a feedback framework 328, an audit trail service 330, generations 332, prompt templates 306, and a one or more flow and/or vector search services 334.

For the purpose of illustration, the trust model 300 is shown with arrows illustrating a simple flow that may employ various components. In practice, however, the trust layer 114 may be used to perform various types of complex operations that may operate outside the linear flow illustrated in the trust model 300. However, the simple flow shown in FIG. 3 may be used to understand the operation and interaction of the various elements included in the trust layer 114.

For the purpose of illustration, consider a request generated by one or more applications and workflows 108. For instance, the request may be natural language text input provided by a user, an operation instruction triggered by an action performed in the context of an application, or some other type of request. Such a request may be sent to the orchestration and inference services 304.

According to various embodiments, the orchestration and inference services 304 may analyze the request to determine an intent, execute one or more actions, generate novel text, interact with the database system, receive and/or transmit one or more messages, and/or perform other types of operations. In service of performing these operations, the orchestration and inference services 304 may access one or more prompt templates 306, one or more actions stored in the action repository 208, and/or other preconfigured definitions or templates.

The orchestration and inference services 304 may transmit information to one or more artificial intelligence libraries 308, which may trigger the retrieval of information via the one or more retrieval augmented generation services 310. The one or more retrieval augmented generation services 310 may retrieve information from inside and/or outside of the computing services environment via the data interface 216 and/or the virtualization interface 218 through the flow and/or vector search interface 334. Retrieved information may be added to a prompt template or used to perform an action.

Prompts and other requests to artificial intelligence models may be processed via one or more toxicity detection and/or data masking services 312. Toxicity detection services, bias detection services, and/or other such evaluators may seek to determine whether a request is likely to generate text or other output deemed biased, offensive, or otherwise unacceptable or impermissible. Data masking may replace some information, such as personally identifying information, with blanks, unique identifiers, or other such values.

Requests may be further processed via one or more metering and/or rate limiting services 314. Metering and/or rate limiting services 314 may help to ensure that requests to models do not exceed a designated rate. For instance, one or more requests may be queued to ensure that a request rate for a designated model, user, organization, or other context does not exceed a designated threshold.

Requests to models may be sent via the model gateway 212. According to various embodiments, the model gateway may be used to access one or more hosted models 318 hosted by the computing services environment 150, one or more tenant models 322 hosted by a customer organization, and/or one or more external models 320 hosted by a third-party service provider. Depending on the configuration, different models may reside inside of the trust layer, outside of the trust layer, and/or in an intermediate zone such as a shared trust environment.

Responses from models, such as prompt completions generated by a generative language model, may be evaluated for toxicity and bias by one or more toxicity and/or bias detection services at 324. Such evaluation may help to ensure that the system does not perform operations or return text that includes impermissible, objectionable, offensive content.

Data demasking may be performed at 326. For instance, personally identifying information in an input prompt to a generative language model may be replaced with randomly generated unique identifiers by one or more data masking services 312. Then, when the generative language model returns a prompt completion that includes one or more of the randomly generated unique identifiers, the identifiers may be replaced with the personally identifying information. In this way, the system may generate text and/or take other actions that include or reflect personally identifying information, while at the same time not exposing such information to services outside the trust model such as externally hosted generative language models.

Feedback regarding actions, text generated by large language models, and/or other such operations may be determined and stored via the feedback framework 328. Such information may be used to train models, guide subsequent actions, and/or otherwise refine the operations of a conversational chat assistant.

The audit trail service 330 may aggregate and store information used to provide a record of actions taken by the system in the course of providing a conversational chat assistant. Such information may be stored in a database system accessible via the computing services environment 150.

Text and other output generated as part of the processing of requests from the requests and workflows 108 may be returned to the applications and workflows 108 as generations at 332. Generations 332 may include, but are not limited to: text to be presented in a chat interface, instructions regarding actions to be performed in the context of providing an application or workflow, or other such information.

### Conversational Chat Assistant Operational Overview

FIG. 4 illustrates an example of a flow 400, performed in accordance with one or more embodiments. The flow 400 is presented to illustrate how interaction with a conversational chat assistant provided via the conversational chat system architecture 200 may be determined and executed.

Input 402 is received via one or more of the applications and workflows 108. In the flow 400 shown in FIG. 4, the input 402 includes a request to book an appointment provided by a user as natural language input via a chat interface. However, different types of input may be provided in other flows. For example, the input may be a request to initiate a workflow within the computing services environment 150. As another example, the input may be generated by an application rather than a user. As yet another example, the input may be a request to interact with a database object within the computing services environment 150.

The input 402 is received by a planner service in the orchestration, planning, and reasoning layer 206. The planner service may evaluate the input to determine one or more operations to perform. In the case of natural language input, the planner service 404 may analyze the natural language input to determine an intent reflected in natural language. For instance, the planner service 404 may determine and transmit an input prompt 406 to a generative language model via the model gateway 212. The generative language model may then determine a prompt completion which is returned to the planner service 404 as a response 408.

In some embodiments, the response 408 may identify one or more actions to perform within the computing services environment. Such actions may be identified by the generative language model by selecting from descriptions of actions included in the input prompt. For instance, the input prompt may include a menu of actions that may potentially be performed in the course of responding to the input 402, and the generative language model may determine a selection of those actions to be performed.

In some embodiments, the initial response returned at 408 may identify a topic. The planner service 404 may use the topic to identify a subset of actions that potentially may be executed to fulfill the intent reflected in the input 402. Descriptions of the subset of actions may then be provided to a generative language model along with the initial input. Based on the input and the descriptions of the subset of actions, the generative language model may select one or more of the subset of actions to formulate a plan. The plan may identify the selected actions, for instance via unique identifiers, for execution by the computing services environment 150.

In the example flow 400 shown in FIG. 4, the actions to be performed to respond to the user request to book an appointment are shown in the plan 412. These actions include verifying the user at 414, generating a one-time password at 416, sending the one-time password at 418, verifying the one-time password at 420, looking up a contact at 422, checking for appointment slot availability at 424, creating a case at 426, and determining a summary of the appointment at 428.

In some embodiments, executing one or more of the actions included in the plan 412 may involve determining additional input prompts to transmit to the model gateway 212. For instance, determining an appointment summary at 428 may involve creating an input prompt that includes a natural language instruction to determine a summary, as well as information about the appointment that a generative language model may use to create the summary.

In some embodiments, executing one or more of the actions included in the plan 412 may involve actions taken by the computing services environment 150 that do not directly involve a generative language model or the model gateway 212. For instance, the computing services environment 150 may communicate with a client machine to send a one-time password at 418, look up a contact for the user in a database at 422, communicate with an external system to check for slot availability at 424, and/or perform other such operations that do not necessarily involve generating novel text via a generative language model.

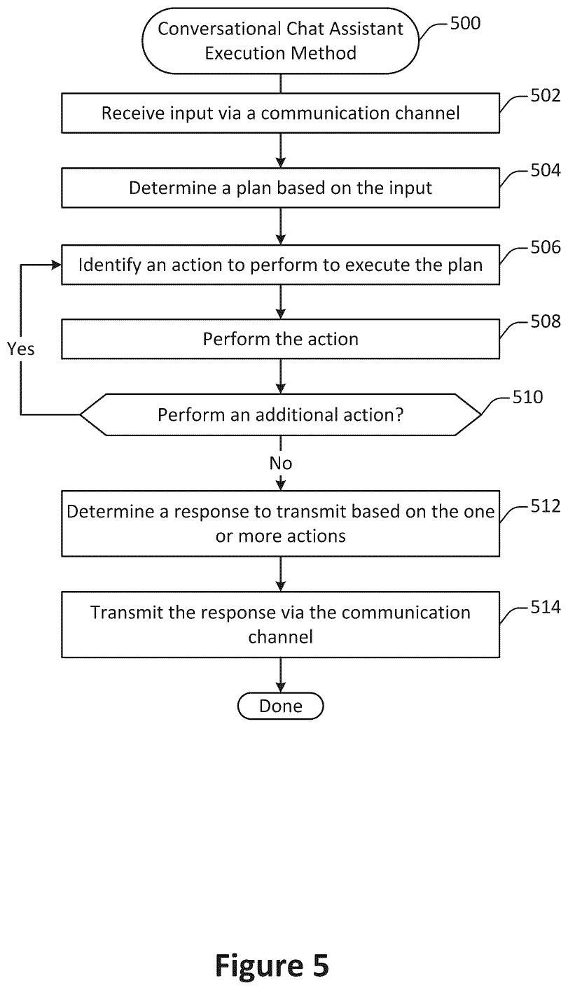

FIG. 5 illustrates a conversational chat assistant execution method 500, performed in accordance with one or more embodiments. In some embodiments, the method 500 may be performed to execute a conversational chat assistant configured in accordance with the conversational chat system architecture 200 shown in FIG. 2.

Input is received via a communication channel at 502. In some embodiments, the input may include natural language text. Alternatively, or additionally, the input may include other types of information, such as a selection of an action to perform based on a button provided in a chat interface, a request sent by an application or workflow, or another such input indicator.

In some embodiments, the communication channel may be a conversational chat interface. For instance, a conversational chat interface may be provided via a web application, mobile application, or other such service. Alternatively, the communication channel may be a messaging service such as email, SMS, Slack, WhatsApp, or any other suitable service for sending and receiving messages.

A plan to execute the user's intent as reflected in the input is determined at 504. In some embodiments, the user input may include an explicit selection of a workflow, action, or other predefined operations. For instance, the input may include a selection of a button corresponding to an action and presented in a conversational chat interface. In such a situation, the action or actions to be performed may be selected from the predefined operations.

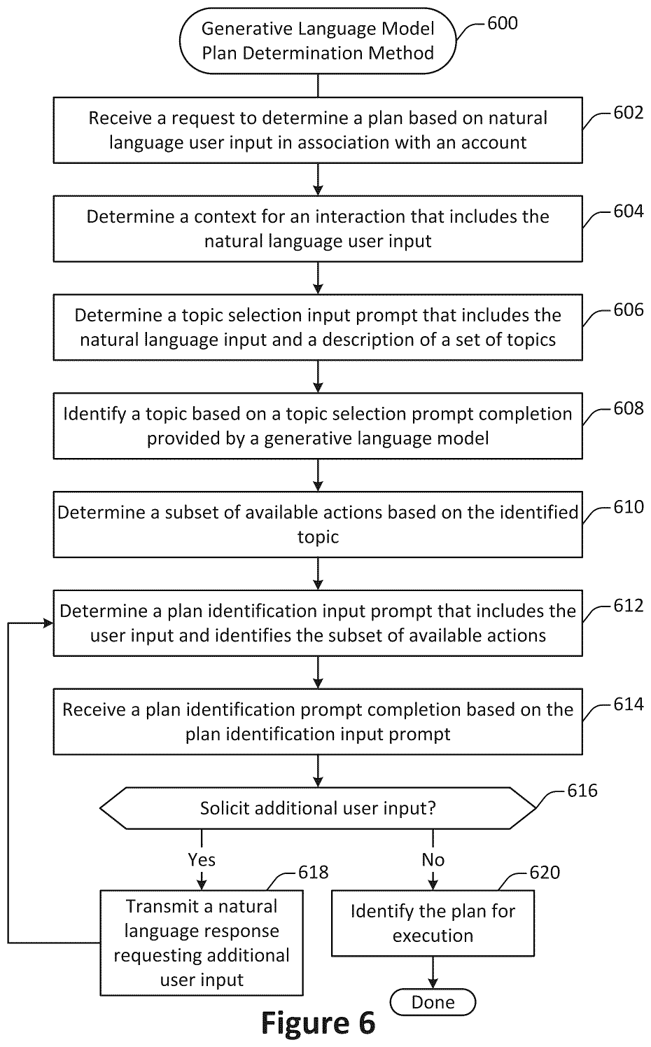

In some embodiments, the user input may be provided via natural language. In such a situation, the user's intent may be less clear and may be determined based on one or more interactions with a generative language model. For instance, natural language text included in the input may be used to determine an intent identification input prompt. The intent identification input prompt may include the input text, a natural language request executable by a generative language model, and/or other types of information. For instance, the intent identification input prompt may include a description of actions capable of being performed via the conversational chat assistant. The generative language model may then generate novel text that includes one or more identifiers corresponding with the actions to be performed based an analysis of the intent in the input text by the generative language model. Additional details regarding a method for determining the user's intent are discussed with respect to the method 600 shown in FIG. 6.

An action to perform to execute the plan is identified at 506. Initially, the application to execute may be the first action in the plan. Subsequently, one or more additional actions may be performed, for instance as discussed with respect to the plan 412 shown in FIG. 4.

The action is performed at 508. According to various embodiments, performing the action may involve executing one or more operations such as sending a message, receiving a message, retrieving data, storing data, generating text via a generative language model, processing or evaluating text, executing an artificial intelligence model other than a generative language model, and/or performing any other suitable operations capable of being performed via the computing services environment 150.

A determination is made at 510 as to whether to perform an additional action. According to various embodiments, actions may be performed in sequence or in parallel. Additional actions may continue to be performed until all actions identified as being indicated by the received input have been performed.

Upon determining not to perform additional actions, a response to transmit is determined at 512 based on the one or more actions. The response is transmitted via the communication channel at 514.

In some embodiments, the response may include natural language output. For instance, the system may generate a textual summary of actions to be performed, a textual response to a query included in the input, a request for additional information, or the like.

In some embodiments, the response may include data. For instance, data responsive to a user query retrieved from the database system, determined by the computing services environment 150, or identified via some other method may be included.

In some embodiments, the response may include an instruction to an application or workflow. For example, the response may include an indication of suggested next action to be presented in a conversational chat interface for possible selection by a user via user input. As another example, the response may include an indication of an operation to be performed by the application or workflow.

FIG. 6 illustrates a method 600 for determining a plan via a generative language model, performed in accordance with one or more embodiments. The method 600 may be performed at a computing services environment such as the computing services environment 150 shown in FIG. 1.

A request to determine a plan based on natural language input in association with an account is received at 602. In some embodiments, the request may be generated as discussed with respect to the operation 504 shown in FIG. 4. For instance, the request may be generated based on natural language input such as “Update the opportunity to be $70,000”, “Book an appointment for me,” “Find the contact for Acme”, or any other type of input.

In some embodiments, the user input may be received in association with an account at the database system. The account may be associated with an individual user. Alternatively, or additionally, the account may be associated with an organization such as an organization accessing computing services via the computing services environment.

A context for an interaction that includes the natural language user input is determined at 604. In some embodiments, the context may include any or all of a variety of information. For example, the context may include one or more identifiers for a user account, an organization account, or any other account within the computing services environment 150. As another example, the context may include one or more previous natural language inputs or other inputs provided by the user. As another example, the context may include one or more natural language outputs or other operations performed by the computing services environment 150 in the course of the interaction. As yet another example, the context may include metadata characterizing the end user, the organization with which the user is interacting, and/or other suitable characteristics. As still another example, the context may include situational data such as a user location, a database record being accessed, a date and time, the weather in a particular location, or any other type of information potentially relevant to the interaction.

In some embodiments, information included and/or determined based on the context determined at 604 may be used to guide the determination of the plan. For instance, a user account may be provided with access only to particular database objects, actions, topics, and/or other elements of the computing services environment 150. Such information may be used, for instance, to guide the determination of the subset of available actions at 610, the determination of a topic at 606 and 608, and/or the identification of a plan at 620.

A topic selection input prompt is determined at 606. The topic selection input prompt includes some or all of the natural language user input and a description of a set of topics. The topic selection input prompt may instruct the generative language model to select from the set of topics for the purpose of identifying prospective actions to perform to fulfill the intent reflected in the user's input.

According to various embodiments, the particular topics that may be selectable may depend upon the context. For example, the computing services environment 150 may provide a set of default topics, such as database system interaction, service-related operations, sales-related operations, and the like. As another example, one or more topics may be tailored to specific industries, organizations, individuals, or other contexts.

The topic is identified at 608 based on a topic selection prompt completion provided by a generative language model. For instance, the generative language model may generate novel text that includes an identifier corresponding to the topic that the generative language model identifies as being most closely related to the user's intent. The identifier may be extracted from the topic selection prompt completion by the computing services environment 150.

In some embodiments, the generative language model may identify more than one topic. For instance, the generative language model may identify the user's intent as being related to sales operations and payment processing topics.

A subset of available actions is determined at 610 based on the identified topic. In some embodiments, an action may be any operation or combination of operations capable of being performed via the computing services environment 150. For instance, an action may include a prompt completed by a generative language model, one or more database operations, an API request, or another type of operation.

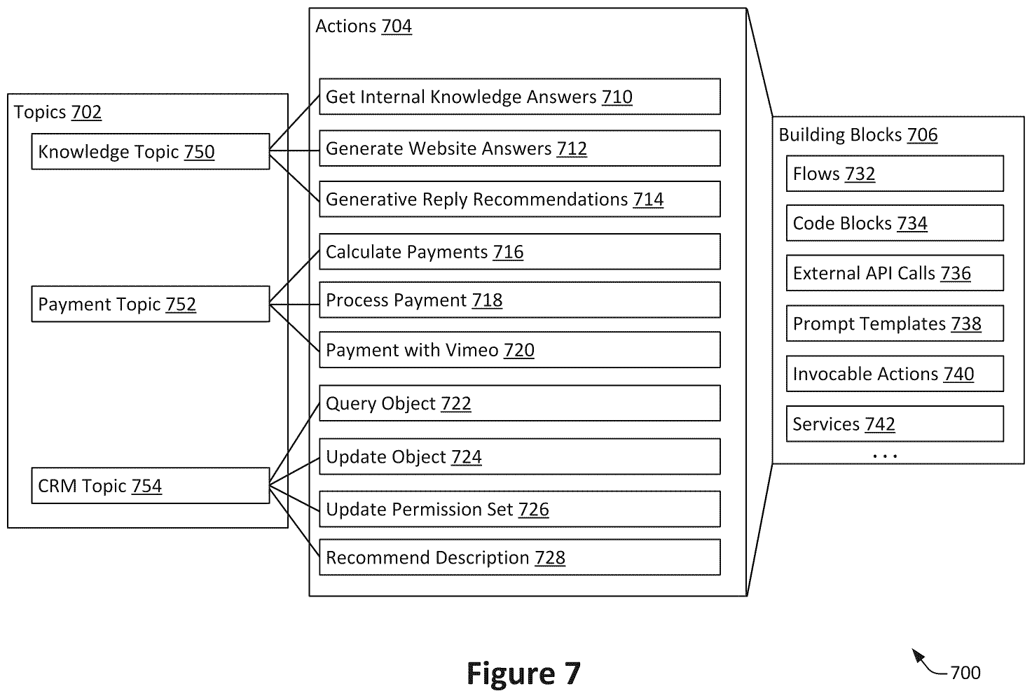

For illustration, FIG. 7 shows a metadata diagram 700 identifying relationships between elements for configuring actions, provided in accordance with one or more embodiments. The metadata diagram 700 includes relationships between topics 702, actions 704, and building blocks 706.

The building blocks 706 include granular operations that may be performed within the computing services environment 70. Examples of building blocks 706 include, but are not limited to, workflows 732, code blocks 734, external API calls 736, prompts determined based on prompt templates 738, other invocable actions 740, and invocable services 742.

Examples of actions are shown at 704. As discussed herein, an action is a logical grouping of operations that optionally includes an input and/or output. Examples of actions include, but are not limited to, getting internal knowledge answers 710, getting website answers 712, generating reply recommendations 714, calculating payments 714, calculating payments 716, processing payments 718, making a payment with Vimeo 720, querying a database object 722, updating a database object 724, updating a permission set 726, and recommending a description 728.

One or more building blocks 706 may be grouped together to form an action, examples of which are shown at 704. As one example, the process payment action 718 may include one or more inputs (e.g., the amount of payment received), one or more outputs (e.g., a summary of the payment processing operation performed), one or more flows 732 for processing the payment, and one or more code blocks 732 executable at different stages of the flow.

A set of topics is shown at 702. The topics 702 include a knowledge topic 750, a payment topic 752, and a customer relations management topic 754. In practice, the conversational chat system architecture 200 may include various numbers and types of topics, actions, and building blocks.

According to various embodiments, the topics 702 may serve as logical groupings of actions. Such groupings may be used to identify a set of actions for which to include descriptions when communicating with a generative language model. For instance, when the user's intent as reflected in user input is to perform an operation related to payment, descriptions of actions associated with the payment topic 752, such as the calculate payment action 716, the process payment action 718, and the payment with Vimeo action 720, may be retrieved and incorporated into an input prompt sent to a generative language model. The generative language model may then complete the prompt by generating novel text that includes identifiers corresponding to one or more of the actions. The computing services environment 70 may then execute the actions corresponding to the identifiers to provide a response to the user.

Returning to FIG. 6, the subset of actions identified may be those linked to the identified topic, as shown in FIG. 7. At 612, a plan identification prompt that includes the user input and identifies the subset of available actions is determined. In some embodiments, the plan identification prompt may list the subset of available actions for selection by the generative language model as part of generating a plan to execute the user's intent.

An example of a prompt template that may be used to determine an intent and/or an orchestration plan as discussed with respect to operation 612 and elsewhere herein is as follows. In the following prompt template, portions such as “{{$history}}” represent fillable portions that can be dynamically replaced with relevant content at runtime to determine an input prompt from the prompt template. For example, “[HISTORY]” may be replaced with natural language input and/or output included in a chat interface. As another example, {{$available_functions}} may include a list of operations that may be performed in response to the input.

<message role=“System”><![CDATA[
Create an XML plan utilizing [AVAILABLE FUNCTIONS] based on the user’s latest
goal as stated in the [HISTORY]. Ensure that the USER GOAL is clearly understood from
the last exchange in the [HISTORY]. Use the context provided by the [HISTORY] to
discern the intent behind previous assistant responses before formulating the plan.
As part of creating the plan also make sure you also include identifying the user’s intent
as expressed in the USER GOAL. Examine the [HISTORY] carefully to understand the
conversation flow and the intent behind the assistant’s responses.
Review the [AVAILABLE FUNCTIONS] thoroughly. Your ability to engage in
conversation is constrained to these functions. Use this information to generate a valid
plan as well as both the category and the intent.
[INTENT INSTRUCTIONS]
Determine the USER INPUT and classify it into one of the following categories:
---
- new: If the user introduces a new subject that aligns with the [AVAILABLE
FUNCTIONS], create a DISTINCT, RELEVANT, and SIGNIFICANT 3-word intent
label for the USER INPUT.
- previous: If the USER INPUT is a continuation of or a response to a prior ASSISTANT
message in the chat history, apply the same intent that was used previously.
- smallTalk: If the user is attempting to engage in casual conversation unrelated to the
[AVAILABLE FUNCTIONS], classify the USER INPUT as smallTalk and skip the
planning step.
For each intent category, use the ‘type’ input to indicate the type of intent (choosing
from new, previous, smallTalk) and the ‘name’ input to provide appropriate details and
represent it under <intent/>.
If the category is small talk, then there is no need to create a plan and skip the function
sequence step.
[END INTENT INSTRUCTIONS]
[SYSTEM FUNCTIONS]
---
- completeAssignment: “Run this command in the end when the Assignment is
completed using AVAILABLE FUNCTIONS below.”
inputs:
properties:
- answer: The answer or result of the assigned task. Please provide user-friendly result
with insights.
type: string
required:
- answer
- askUser: “Run when assistant need to get input from the user. This function can accept
only one input from the user.”
inputs:
properties:
- question: The question to the user.
type: string
required:
- question
[END SYSTEM FUNCTIONS]
[AVAILABLE FUNCTIONS]
{{$available_functions}}
[END AVAILABLE FUNCTIONS]
[TYPE DEFINITION]
{{$type_definitions}}
[END TYPE DEFINITION]
Today is: {{$today}}
[LOCALE]
{{$local}}
[END LOCALE]
[FUNCTION POLICIES]
1. For Copilot_v1.EmployeeCopilot_IdentifyRecordByName function you are allowed
to use Salesforce Object Api Names from this given list ONLY: {{$object_api_names}}.
Skip Object API Name when you are not confident.
[END FUNCTION POLICIES]
[FUNCTION INSTRUCTIONS]
CRUCIAL:
To call a function, follow these steps:
1. A function has one or more named parameters and a single ‘output’ which are all
strings. Parameter values should be xml escaped.
2. To save an ‘output’ from a <function>, to pass into a future <function>, use
<fn.{FullyQualifiedFunctionName} ... output=“<UNIQUE_VARIABLE_KEY>”/>
3. To save an ‘output’ from a <function>, to return as part of a plan result, use
<fn.{FullyQualifiedFunctionName} ... result=“<UNIQUE_RESULT_KEY>”/>
4. Use a ‘$’ to reference a context variable in a parameter, e.g. when ‘INPUT=‘world’’
the parameter ‘Hello $INPUT’ will evaluate to ‘Hello world’.
5. Functions do not have access to the context variables of other functions. Do not
attempt to use context variables as arrays or objects. Instead, use available functions
to extract specific elements or properties from context variables.
6. Make sure that all REQUIRED parameters for function are populated from previous
function output or history or user input.
DO NOT DO THIS, THE PARAMETER VALUE IS NOT XML ESCAPED:
<fn.Name4 input=“$SOME_PREVIOUS_OUTPUT” parameter_name=“some value with
a <!-- ‘comment’ in it-->”/>
DO NOT DO THIS, THE PARAMETER VALUE IS ATTEMPTING TO USE A
CONTEXT VARIABLE AS AN ARRAY/OBJECT:
<fn.CallFunction input=“$OTHER_OUTPUT[1]”/>
Here is a valid example of how to call a function “_Function_.Name” with a single input
and save its output:
<fn._Function_.Name input=“this is my input” output=“SOME_KEY”/>
Here is a valid example of how to call a function “FunctionName2” with a single input
and return its output as part of the plan result:
<fn.FunctionName2 input=“Hello $INPUT” result=“FINAL_ANSWER”/>
Here is a valid example of how to call a function “Name3” with multiple inputs:
<fn.Name3 input=“$SOME_PREVIOUS_OUTPUT” parameter_name=“some value with
a &lt;!-- &apos;comment&apos; in it--$gt;”/>
[END FUNCTION INSTRUCTIONS]
[PLAN INSTRUCTIONS]
CRUCIAL:
To create a plan, follow these steps:
0. The plan should be as short as possible.
1. From a USER GOAL create a <plan> as a series of functions.
2. Use [HISTORY] to get the context for <goal>. [HISTORY] is conversation history
between you and the user. User might have provided information as part of the history.
Use that when creating <plan>.
3. If present, use [EXISTING PLAN] as reference when creating a new plan. Update the
existing plan as appropriate based on [HISTORY]
4. If [PLAN ERROR] has errors it means that you previously generated an incorrect plan,
and you are NOW being asked to RECREATE the plan by FIXING the errors specified
in the [PLAN ERROR].
5. A plan has ‘INPUT’ available in context variables by default.
6. Before using any function in a plan, check that it is present in the [AVAILABLE
FUNCTIONS] list. If it is not, do not use it.
7. Only use functions that are required for the given USER GOAL.
8. Append an “END” XML comment at the end of the plan after the final closing </plan>
tag.
9. Always output valid XML that can be parsed by an XML parser.
10. Always use at least one AVAILABLE FUNCTION.
11. If a plan cannot be created with the [AVAILABLE FUNCTIONS], return <plan />.
12. Use the [TYPE DEFINITION] section to get the type definitions for the [AVAILABLE
FUNCTIONS] input and outpput properties. All references to the output of the function
MUST be referenced as $<UNIQUE_VARIABLE_KEY>.<property_name> where
‘property_name’ represents the fully qualified name of the function property. For eg if
the function output with a property named ‘output’, then the reference to that
property will be $<UNIQUE_VARIABLE_KEY>.output.
13. Use the [FUNCTION POLICIES] section to enforce any prerequisites.
[END PLAN INSTRUCTIONS]
CRUCIAL:
When generating the output, you must evaluate the outcome of the execution in
relation to the provided [HISTORY] and the USER GOAL. It is imperative that you follow
all guidelines outlined in the [INTENT INSTRUCTIONS], [PLAN INSTRUCTIONS],
and [FUNCTION INSTRUCTIONS].
Your output must be formatted exclusively in the XML structure shown below. Do not
include any additional text or elements outside of this structure. Do not provide
[INTENT] and [PLAN] only xml should be provided.
′′′xml
<intent type=“Specify one: new, previous, smallTalk” name=“Provide a concise intent
label according to the requirements for the chosen category” />
<plan>
<fn.{FullyQualifiedFunctionName} ... />
<fn.{FullyQualifiedFunctionName} ... />
<fn.{FullyQualifiedFunctionName} ... />
<!-- Continue to add function calls as necessary -->
</plan>
′′′
Remember, the output must contain only the <plan> XML element and its contents as
specified. No other text or elements should be included in the output.
Begin!
]]></message>
<message role=“User”><![CDATA[
[HISTORY]
{{$history}}
- role: USER
message:
text: {{$input}}
[END HISTORY]
[EXISTING PLAN]
{{$existing_plan}}
[END EXISTING PLAN]
[PLAN ERROR]
{{$plan_error}}
[END PLAN ERROR]
]]></message>

A plan identification prompt completion is received at 614 based on the plan identification input prompt. The plan identification input prompt may include novel text generated by the generative language model in response to receiving the plan identification input prompt.

A determination is made at 616 as to whether to select additional input. In some embodiments, upon determining that the plan identification prompt completion includes information sufficient for identifying a plan for execution, the plan may be identified at 620. For example, the plan identification prompt completion may include a plan for execution. For instance, the plan identification prompt completion may include a set of identifiers corresponding to a selected one or more actions of the subset of actions determined at 610.

In some embodiments, the selected one or more actions may be arranged in a linear fashion. For instance, the selected one or more actions may be identified in a sequence for execution by the computing services environment 150 to execute the user's intent.

In some embodiments, the selected one or more actions may be arranged in a branching, parallel, or otherwise non-linear fashion. For example, the outcome of one action may influence which of two or more possible subsequent actions are performed. As another example, multiple actions may be performed at the same time or in any suitable order.

In some embodiments, upon determining instead that the plan identification prompt completion does not include information sufficient for identifying a complete plan for execution, a natural language response requesting additional user input may be transmitted at 616.

As an example of when additional user input may be indicated, consider a situation in which a user provides natural language input stating “Update the opportunity to be $70,000”. In response to this input, the computing services environment 150 may identify “database interaction” as a suitable topic. However, in response to a request to determine a plan to execute the user's intent, the generative language model may observe that the action to update an opportunity object requires as input an identifier for an opportunity object but that the opportunity object to update is not apparent. In such a situation, the generative language model may return a clarification question rather than a plan for execution. For instance, the generative language model may return natural language input such as “Which opportunity object would you like me to update?”.

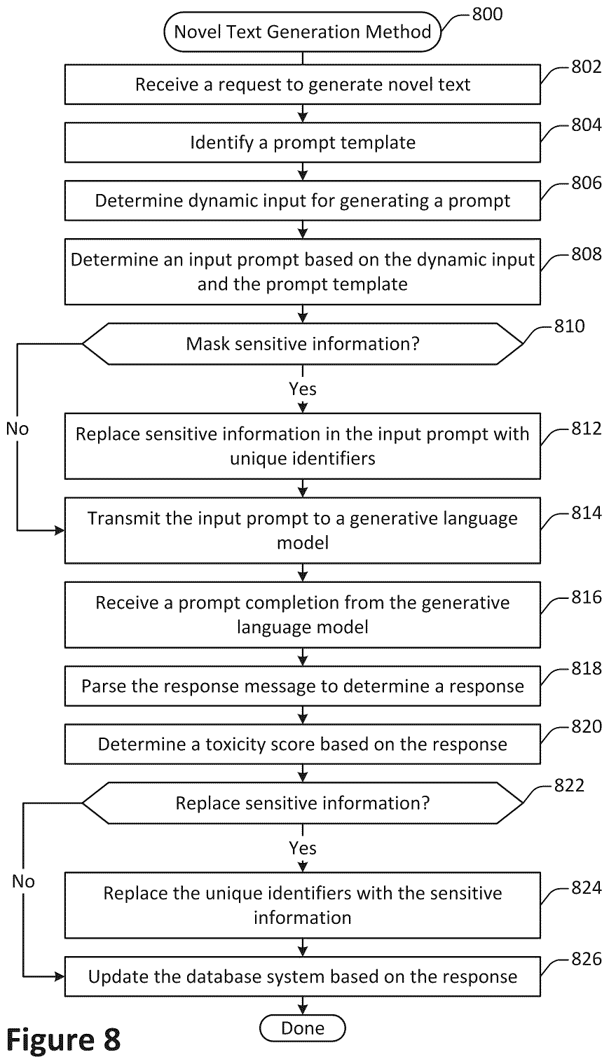

FIG. 8 illustrates a method 800 for generating novel text, performed in accordance with one or more embodiments. The method 800 may be performed at the computing services environment 150. The method 800 may be performed in order to complete a prompt in the course of executing an orchestration plan such as a plan determined as discussed with respect to FIG. 4.

According to various embodiments, an orchestration plan may include one or more operations to perform to execute the intent. For example, a contact record summarization orchestration may include a first operation to perform a vector search of a database system to identify a contact record for Alexandra, and a second operation to determine and complete a generative language model prompt summarizing the information included in the contact record.

In particular embodiments, the method 800 may be executed multiple times to determine a natural language response. For example, an initial natural language instruction to “Summarize Alexandra's record” may prompt a clarifying natural language response stating that: “Alexandra has both a contact and an account record. Would you like me to summarize Alexandra's contact record or Alexandra's account record?” The method 800 may then be executed again to produce the summary based on a clarifying response provided by the user.

According to various embodiments, customer organizations can specify the type of orchestration being performed. For example, an orchestration may be a stepwise process in which a sequence of steps is executed in order, potentially with branches and/or dependencies. As another example, an orchestration may be a set of operations performed in parallel or all at once. As still another example, an orchestration may be a complex interrelated set of operations organized in a graph structure, the execution of which is interdependent. Standard orchestrations may be used, or a customer organization can provide its own orchestrations. Further, an orchestration may trigger other orchestrations, and/or be used to resolve which of a set of orchestrations to execute.

In some embodiments, natural language may be used to generate prompts. For example, a customer organization may specify the content of prompts to use in a prompt builder, either manually or by describing a prompt in natural language.

A request to execute a prompt is received at 802. In some embodiments, the request may be generated by a conversational chat assistant. For example, the request may be generated in the course of executing an action included in a plan. For instance, the action may involve drafting an email, determining a summary of a record, or generating novel text in any of various types of situations.

A prompt template is identified at 804. According to various embodiments, the particular prompt template identified at 804 may depend in significant part on the context. For instance, the prompt template may be identified based on the request received at 802, which may identify an action configured in accordance with techniques and mechanisms discussed herein. For example, an action to generate a summary of a database record may include as input a database record identifier and may be associated with a prompt template for summarizing the information. The prompt template for summarizing the database record may include fillable fields corresponding with fields associated with the database record, as well as natural language instructions to be executed by the generative language model to generate novel text summarizing the record.

Dynamic input for generating an input prompt is determined at 806. In some embodiments, some or all of the dynamic input information may be retrieved from the database system. For instance, a record identifier may be used to query the database system to retrieve fields corresponding with a database object. Alternatively, or additionally, some or all of the dynamic input information may be retrieved from a different data source, such as via an external API.

In some embodiments, some or all of the dynamic input information may be determined based on an interaction with a conversational chat assistant. For instance, some or all of natural language input provided by an end user and/or natural language output generated in response by a conversational chat assistant may be identified for inclusion in the prompt. In this way, the generative language model may be provided with the natural language context associated with the request to generate novel natural language.

An input prompt is determined at 808 based on the dynamic input and the prompt template. In some embodiments, determining the dynamic input may involve replacing one or more fillable portions of the prompt template with some or all of the dynamic input information determined as discussed with respect to the operation 806.

A determination is made at 810 as to whether to mask sensitive information. In some embodiments, the determination may be made at least in part based on configuration information. For example, some types of database fields, action inputs, or other information may be identified as including personally identifying information.

Upon determining to mask sensitive information, sensitive information in the prompt is identified and replaced with unique identifiers at 812. In some embodiments, sensitive information may be identified as such by the database system, for instance when it is retrieved from the database. Alternatively, or additionally, sensitive information may be identified dynamically, for instance by analyzing the prompt to identify information such as names, addresses, identifiers, and other such information.

In some embodiments, the use of a unique identifier may allow sensitive information to be replaced when the completion is received from the generative language model. For example, a name may be replaced with an identifier such as “NAME OF PERSON 35324”. As another example, an address may be replaced with a more general description of a place, such as “LOCATION ID 53342 CITY, STATE, COUNTRY”, with the street and building number omitted. As yet another example, a database record identifier may be replaced with a substitute identifier.

The input prompt is transmitted to a generative language model for execution at 814. In some embodiments, the input prompt may be sent to the generative language model via the model gateway 212. The particular generative language model to which the prompt is sent may be dynamically determined. For instance, different generative language models may have different characteristics. Accordingly, the input prompt may include elements tailored to the specific generative language model to which the input prompt is sent.

A prompt completion is received from the generative language model at 816. According to various embodiments, the prompt completion may include novel text determined by the generative language model based on the raw prompt. The prompt completion may be received in a response message via the model gateway 212 shown in FIG. 2.

The response message is parsed at 818 to determine a response. In some embodiments, parsing the response message may include extracting the novel text from the response message and optionally performing one or more post-processing operations on the novel text. For instance, the novel text may be placed within a response template or combined with information retrieved from the database system.

A toxicity score is determined at 820 based on the response. In some embodiments, the toxicity score may evaluate the novel text determined by the generative language model via a toxicity model configured to evaluate text toxicity. The toxicity model may identify text characteristics such as sentiment, negativity, hate speech, harmful information, and/or stridency, for instance based on the presence of inflammatory words or phrases, punctuation patterns, and other indicators.

In some embodiments, information about bias may be determined instead of, or in addition to, a toxicity score. Bias detection may involve evaluating generated text to determine, for instance, whether it favors a particular point of view.

A determination is made at 822 as to whether to replace sensitive information in the completion. The determination may be made based on whether sensitive information was masked at operations 810 and 812. Upon determining to replace sensitive information, the unique identifiers added to the prompt at 812 may be replaced with the corresponding sensitive information at 824.

The database system is updated based on the response at 826. According to various embodiments, updating the database system may involve storing, removing, or updating one or more records in the database system. For instance, the response may include novel text to include in a database system record. Alternatively, or additionally, updating the database system may involve transmitting a response to a client machine, an application server, or another recipient. The response may include some or all of the novel text. As still another possibility, updating the database system may involve sending an email or other such message including some or all of the novel text.

In some embodiments, updating the database system may involve storing and/or transmitting the toxicity score. For example, the toxicity score may be presented in a graphical user interface of a web application in which the novel text determined by the generative language model is shown.

In some embodiments, a prompt template may be associated with a prompt class. For example, a system prompt template may be configured and executed by the computing services environment provider. As another example, a user prompt template may be configured and executed by a user of the database system. As yet another example, a conversational chat assistant prompt template may be configured and executed in the context of a messaging interaction.

In some embodiments, some elements discussed with respect to the method 800 shown in FIG. 8 may be determined based at least in part on a security level associated with a prompt template. For example, a system prompt template may have no need for checks related to injection attacks. However, protections against injection attacks may be required for an assistant prompt template or a user prompt template. For example, a system prompt template may have no need for checks related to toxicity, bias, and the like. However, protections against toxicity and bias may be optionally specified as configuration parameters for an assistant prompt template or a user prompt template.

### Computing Services Environment Architecture

FIG. 9 shows a block diagram of an example of an environment 910 that includes an on-demand database service configured in accordance with some implementations. Environment 910 may include user systems 912, network 914, database system 916, processor system 917, application platform 918, network interface 920, tenant data storage 922, tenant data 923, system data storage 924, system data 925, program code 926, process space 928, User Interface (UI) 930, Application Program Interface (API) 932, PL/SOQL 934, save routines 936, application setup mechanism 938, application servers 950-1 through 950-N, system process space 952, tenant process spaces 954, tenant management process space 960, tenant storage space 962, user storage 964, and application metadata 966. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 916, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 918 may be a framework that allows the creation, management, and execution of applications in system 916. Such applications may be developed by the database service provider or by users or third-party application developers accessing the service. Application platform 918 includes an application setup mechanism 938 that supports application developers' creation and management of applications, which may be saved as metadata into tenant data storage 922 by save routines 936 for execution by subscribers as one or more tenant process spaces 954 managed by tenant management process 960 for example. Invocations to such applications may be coded using PL/SOQL 934 that provides a programming language style interface extension to API 932. A detailed description of some PL/SOQL language implementations is discussed in commonly assigned U.S. Pat. No. 9,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 966 for a subscriber making such an invocation. Such system processes may also manage execution of application metadata 966 as an application in a virtual machine.

In some implementations, each application server 950 may handle requests for any user associated with any organization. A load balancing function (e.g., an F5 Big-IP load balancer) may distribute requests to the application servers 950 based on an algorithm such as least-connections, round robin, observed response time, etc. Each application server 950 may be configured to communicate with tenant data storage 922 and the tenant data 923 therein, and system data storage 924 and the system data 925 therein to serve requests of user systems 912. The tenant data 923 may be divided into individual tenant storage spaces 962, which can be either a physical arrangement and/or a logical arrangement of data. Within each tenant storage space 962, user storage 964 and application metadata 966 may be similarly allocated for each user. For example, a copy of a user's most recently used (MRU) items might be stored to user storage 964. Similarly, a copy of MRU items for an entire tenant organization may be stored to tenant storage space 962. A UI 930 provides a user interface and an API 932 provides an application programming interface to system 916 resident processes to users and/or developers at user systems 912.

System 916 may implement a web-based generative language model system. For example, in some implementations, system 916 may include application servers configured to implement and execute generative language model software applications. The application servers may be configured to provide related data, code, forms, web pages and other information to and from user systems 912. Additionally, the application servers may be configured to store information to, and retrieve information from a database system. Such information may include related data, objects, and/or Webpage content. With a multi-tenant system, data for multiple tenants may be stored in the same physical database object in tenant data storage 922, however, tenant data may be arranged in the storage medium(s) of tenant data storage 922 so that data of one tenant is kept logically separate from that of other tenants. In such a scheme, one tenant may not access another tenant's data, unless such data is expressly shared.

Several elements in the system shown in FIG. 9 include conventional, well-known elements that are explained only briefly here. For example, user system 912 may include processor system 912A, memory system 912B, input system 912C, and output system 912D. A user system 912 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 912 to access, process and view information, pages and applications available from system 916 over network 914. Network 914 may be any network or combination of networks of devices that communicate with one another, such as any one or any combination of a LAN (local area network), WAN (wide area network), wireless network, or other appropriate configuration.

The users of user systems 912 may differ in their respective capacities, and the capacity of a particular user system 912 to access information may be determined at least in part by “permissions” of the particular user system 912. As discussed herein, permissions generally govern access to computing resources such as data objects, components, and other entities of a computing system, such as a generative language model platform, a social networking system, and/or a CRM database system. “Permission sets” generally refer to groups of permissions that may be assigned to users of such a computing environment. For instance, the assignments of users and permission sets may be stored in one or more databases of System 916. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 916 may provide on-demand database service to user systems 912 using an MTS arrangement. By way of example, one tenant organization may be a company that employs a sales force where each salesperson uses system 916 to manage their sales process. Thus, a user in such an organization may maintain contact data, leads data, customer follow-up data, performance data, goals and progress data, etc., all applicable to that user's personal sales process (e.g., in tenant data storage 922). In this arrangement, a user may manage his or her sales efforts and cycles from a variety of devices, since relevant data and applications to interact with (e.g., access, view, modify, report, transmit, calculate, etc.) such data may be maintained and accessed by any user system 912 having network access.

When implemented in an MTS arrangement, system 916 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 916 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 916 may also maintain system-level data usable by multiple tenants or other data. Such system-level data may include industry reports, news, postings, and the like that are sharable between tenant organizations.

In some implementations, user systems 912 may be client systems communicating with application servers 950 to request and update system-level and tenant-level data from system 916. By way of example, user systems 912 may send one or more queries requesting data of a database maintained in tenant data storage 922 and/or system data storage 924. An application server 950 of system 916 may automatically generate one or more SQL statements (e.g., one or more SQL queries) that are designed to access the requested data. System data storage 924 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 9,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

FIG. 10A shows a system diagram of an example of architectural components of an on-demand database service environment 1000, configured in accordance with some implementations. A client machine located in the cloud 1004 may communicate with the on-demand database service environment via one or more edge routers 1008 and 1012. A client machine may include any of the examples of user systems 912 described above. The edge routers 1008 and 1012 may communicate with one or more core switches 1020 and 1024 via firewall 1016. The core switches may communicate with a load balancer 1028, which may distribute server load over different pods, such as the pods 1040 and 1044 by communication via pod switches 1032 and 1036. The pods 1040 and 1044, which may each include one or more servers and/or other computing resources, may perform data processing and other operations used to provide on-demand services. Components of the environment may communicate with a database storage 1056 via a database firewall 1048 and a database switch 1052.

Accessing an on-demand database service environment may involve communications transmitted among a variety of different components. The environment 1000 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 10A and 10B.

The cloud 1004 refers to any suitable data network or combination of data networks, which may include the Internet. Client machines located in the cloud 1004 may communicate with the on-demand database service environment 1000 to access services provided by the on-demand database service environment 1000. By way of example, client machines may access the on-demand database service environment 1000 to retrieve, store, edit, and/or process generative language model information.

In some implementations, the edge routers 1008 and 1012 route packets between the cloud 1004 and other components of the on-demand database service environment 1000. The edge routers 1008 and 1012 may employ the Border Gateway Protocol (BGP). The edge routers 1008 and 1012 may maintain a table of IP networks or ‘prefixes’, which designate network reachability among autonomous systems on the internet.

In one or more implementations, the firewall 1016 may protect the inner components of the environment 1000 from internet traffic. The firewall 1016 may block, permit, or deny access to the inner components of the on-demand database service environment 1000 based upon a set of rules and/or other criteria. The firewall 1016 may act as one or more of a packet filter, an application gateway, a stateful filter, a proxy server, or any other type of firewall.

In some implementations, the core switches 1020 and 1024 may be high-capacity switches that transfer packets within the environment 1000. The core switches 1020 and 1024 may be configured as network bridges that quickly route data between different components within the on-demand database service environment. The use of two or more core switches 1020 and 1024 may provide redundancy and/or reduced latency.

In some implementations, communication between the pods 1040 and 1044 may be conducted via the pod switches 1032 and 1036. The pod switches 1032 and 1036 may facilitate communication between the pods 1040 and 1044 and client machines, for example via core switches 1020 and 1024. Also or alternatively, the pod switches 1032 and 1036 may facilitate communication between the pods 1040 and 1044 and the database storage 1056. The load balancer 1028 may distribute workload between the pods, which may assist in improving the use of resources, increasing throughput, reducing response times, and/or reducing overhead. The load balancer 1028 may include multilayer switches to analyze and forward traffic.

In some implementations, access to the database storage 1056 may be guarded by a database firewall 1048, which may act as a computer application firewall operating at the database application layer of a protocol stack. The database firewall 1048 may protect the database storage 1056 from application attacks such as structure query language (SQL) injection, database rootkits, and unauthorized information disclosure. The database firewall 1048 may include a host using one or more forms of reverse proxy services to proxy traffic before passing it to a gateway router and/or may inspect the contents of database traffic and block certain content or database requests. The database firewall 1048 may work on the SQL application level atop the TCP/IP stack, managing applications' connection to the database or SQL management interfaces as well as intercepting and enforcing packets traveling to or from a database network or application interface.

In some implementations, the database storage 1056 may be an on-demand database system shared by many different organizations. The on-demand database service may employ a single-tenant approach, a multi-tenant approach, a virtualized approach, or any other type of database approach. Communication with the database storage 1056 may be conducted via the database switch 1052. The database storage 1056 may include various software components for handling database queries. Accordingly, the database switch 1052 may direct database queries transmitted by other components of the environment (e.g., the pods 1040 and 1044) to the correct components within the database storage 1056.

FIG. 10B shows a system diagram further illustrating an example of architectural components of an on-demand database service environment, in accordance with some implementations. The pod 1044 may be used to render services to user(s) of the on-demand database service environment 1000. The pod 1044 may include one or more content batch servers 1064, content search servers 1068, query servers 1082, file servers 1086, access control system (ACS) servers 1080, batch servers 1084, and app servers 1088. Also, the pod 1044 may include database instances 1090, quick file systems (QFS) 1092, and indexers 1094. Some or all communication between the servers in the pod 1044 may be transmitted via the switch 1036.

In some implementations, the app servers 1088 may include a framework dedicated to the execution of procedures (e.g., programs, routines, scripts) for supporting the construction of applications provided by the on-demand database service environment 1000 via the pod 1044. One or more instances of the app server 1088 may be configured to execute all or a portion of the operations of the services described herein.

In some implementations, as discussed above, the pod 1044 may include one or more database instances 1090. A database instance 1090 may be configured as an MTS in which different organizations share access to the same database, using the techniques described above. Database information may be transmitted to the indexer 1094, which may provide an index of information available in the database 1090 to file servers 1086. The QFS 1092 or other suitable filesystem may serve as a rapid-access file system for storing and accessing information available within the pod 1044. The QFS 1092 may support volume management capabilities, allowing many disks to be grouped together into a file system. The QFS 1092 may communicate with the database instances 1090, content search servers 1068 and/or indexers 1094 to identify, retrieve, move, and/or update data stored in the network file systems (NFS) 1096 and/or other storage systems.

In some implementations, one or more query servers 1082 may communicate with the NFS 1096 to retrieve and/or update information stored outside of the pod 1044. The NFS 1096 may allow servers located in the pod 1044 to access information over a network in a manner similar to how local storage is accessed. Queries from the query servers 1022 may be transmitted to the NFS 1096 via the load balancer 1028, which may distribute resource requests over various resources available in the on-demand database service environment 1000. The NFS 1096 may also communicate with the QFS 1092 to update the information stored on the NFS 1096 and/or to provide information to the QFS 1092 for use by servers located within the pod 1044.

In some implementations, the content batch servers 1064 may handle requests internal to the pod 1044. These requests may be long-running and/or not tied to a particular customer, such as requests related to log mining, cleanup work, and maintenance tasks. The content search servers 1068 may provide query and indexer functions such as functions allowing users to search through content stored in the on-demand database service environment 1000. The file servers 1086 may manage requests for information stored in the file storage 1098, which may store information such as documents, images, basic large objects (BLOBs), etc. The query servers 1082 may be used to retrieve information from one or more file systems. For example, the query system 1082 may receive requests for information from the app servers 1088 and then transmit information queries to the NFS 1096 located outside the pod 1044. The ACS servers 1080 may control access to data, hardware resources, or software resources called upon to render services provided by the pod 1044. The batch servers 1084 may process batch jobs, which are used to run tasks at specified times. Thus, the batch servers 1084 may transmit instructions to other servers, such as the app servers 1088, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

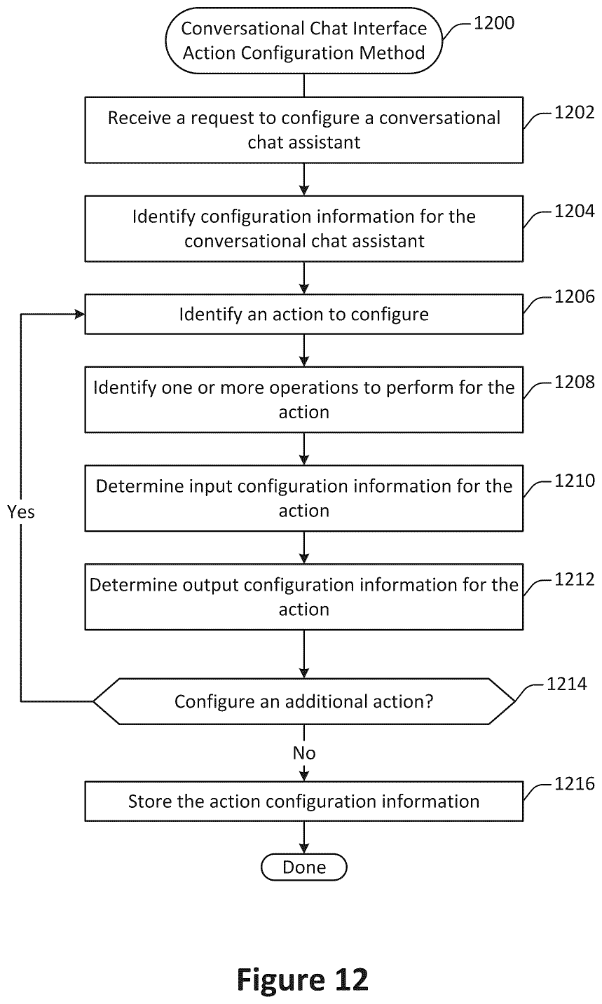

FIG. 11 illustrates one example of a computing device. According to various embodiments, a system 1100 suitable for implementing embodiments described herein includes a processor 1101, a memory module 1103, a storage device 1105, an interface 1111, and a bus 1115 (e.g., a PCI bus or other interconnection fabric.) System 1100 may operate as variety of devices such as an application server, a database server, or any other device or service described herein. Although a particular configuration is described, a variety of alternative configurations are possible. The processor 1101 may perform operations such as those described herein. Instructions for performing such operations may be embodied in the memory 1103, on one or more non-transitory computer readable media, or on some other storage device. Various specially configured devices can also be used in place of or in addition to the processor 1101. The interface 1111 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

### Action Configuration

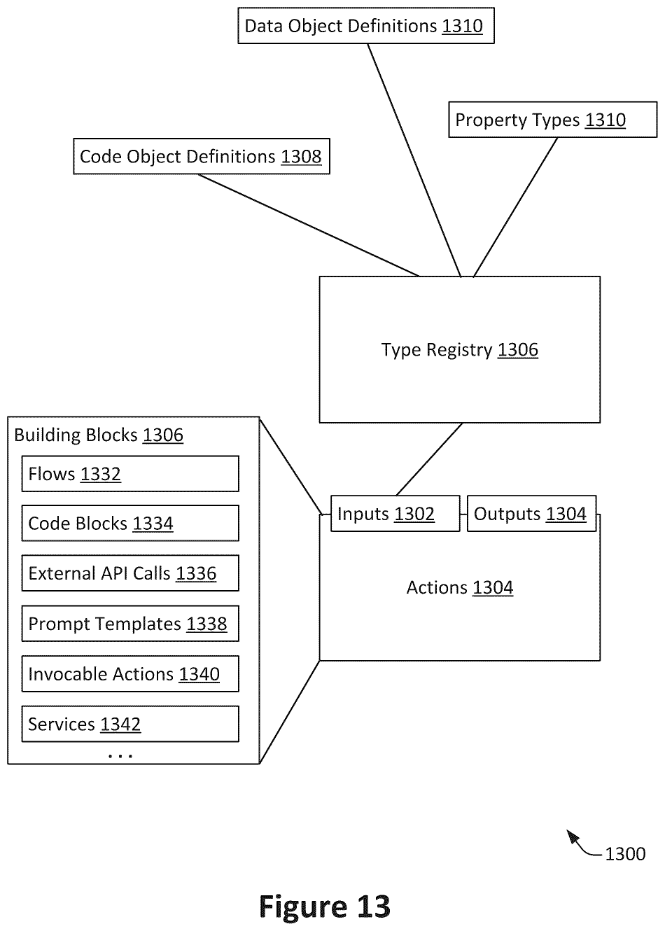

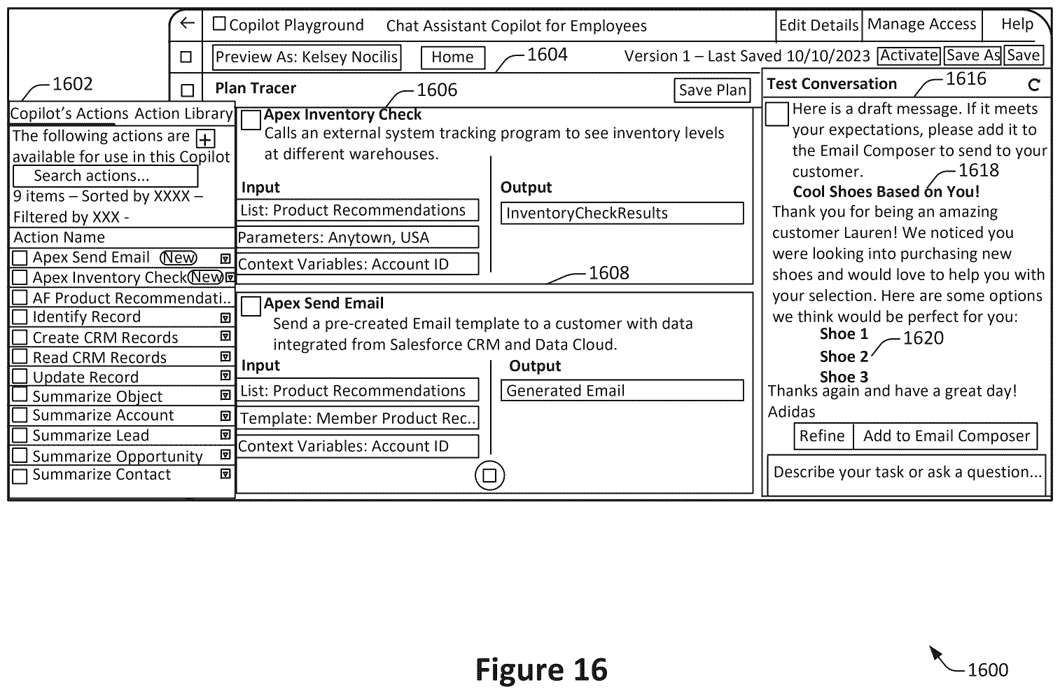

FIG. 12 illustrates a method 1200 for configuring a conversational chat assistant, performed in accordance with one or more embodiments. The method 1200 may be performed at the computing services environment computing services environment 150 shown in FIG. 2. For instance, the method 1200 may be performed at the conversational chat studio 112 in communication with a client machine. Examples of a user interface for testing a conversational chat assistant configured as discussed with respect to FIG. 12 are shown in FIG. 15 and FIG. 16.

A request to configure a conversational chat assistant is received at 1202. In some embodiments, the request may be received from a client machine in communication with the computing services environment 150. In some configurations, the conversational chat assistant may be configured for general use for different parties and contexts within the computing services environment. Alternatively, the conversational chat assistant may be configured for a particular customer organization, product offering, service offering, or other context.

Configuration information for the conversational chat assistant is identified at 1204. In some embodiments, the configuration information may be provided via the user interface. The configuration information may include information such as a name, description, context, and/or other metadata for the conversational chat assistant.

In some implementations, the configuration information may include one or more natural language instructions to be executed by a generative language model. For instance, the configuration information may include overarching natural language instructions governing the generation of novel text in conjunction with the conversational chat assistant. Such instructions may indicate to a generative language model that novel text is to be generated in a manner that is, for example, helpful, clear, professional, and respectful.

An action to configure is identified at 1206. In some embodiments, the action to configure may be identified based on selection by a user via a user interface. The user may identify an existing action to adapt for the conversational chat assistant and/or provide information for creating a new action.

One or more operations to perform for the action are identified at 1208. According to various embodiments, any of various types of operations may be performed when executing an action. For example, a prompt may be created from a prompt template and sent to a generative language model for completion. As another example, information may be retrieved from the database system or another data source. As yet another example, one or more records in a database system or other data source may be updated. As still another example, an API call may be sent via an internal or external API.

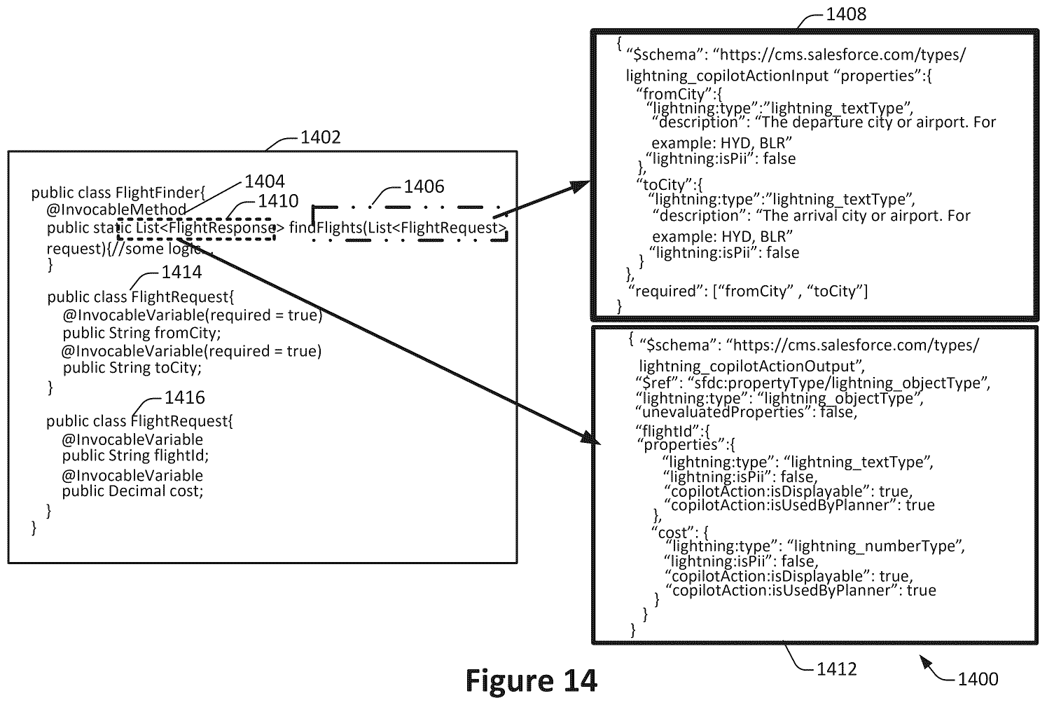

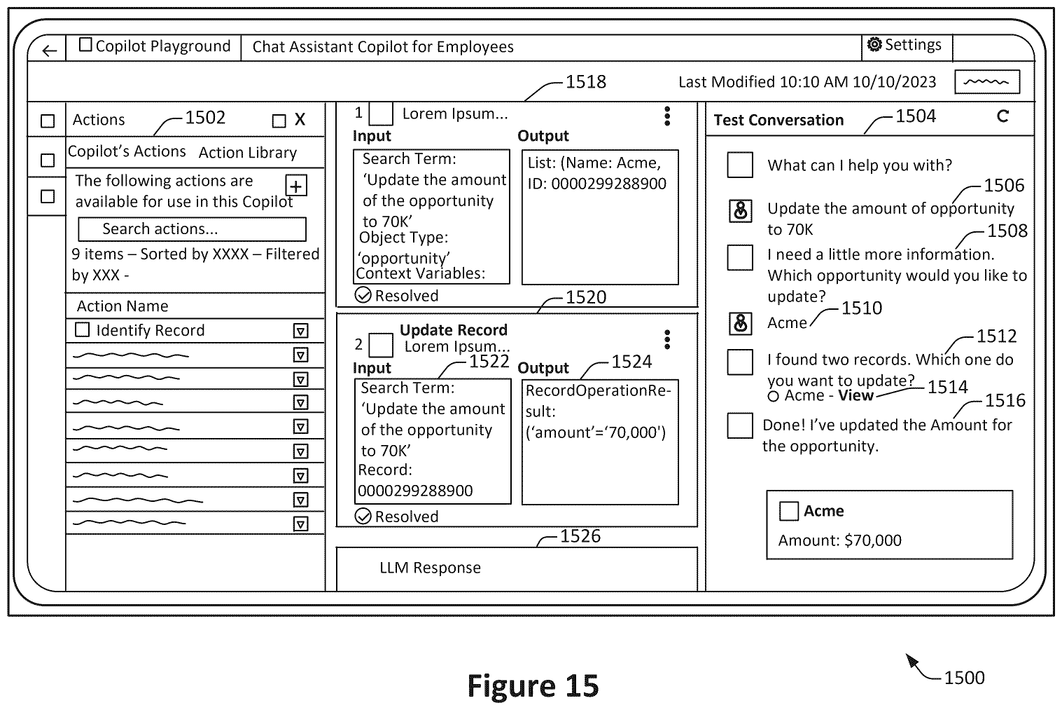

An input configuration for the action is determined at 1210, and an output configuration for the action is determined at 1212. In some embodiments, an input configuration and an output configuration may be specified in terms of one or more parameters provided to initiate the action and information returned by the completion of the action, respectively. Such information may be specified in accordance with a metadata-based type system. For instance, as shown in additional detail in FIG. 13 and FIG. 14, an input or output may be associated with an entry in a type registry that defines the input or output as a code object, a data object, a primitive, or another data type.

In some embodiments, the input or output configuration may be determined based on user input. Alternatively, or additionally, the input or output configuration information may be determined based on the one or more operations to perform at 1208. For example, particular types of actions may be linked with particular types of inputs or outputs. For instance, a call to a generative language model may take as input both a prompt template and a source for textual information used to determine a prompt from the prompt template.

A determination is made at 1214 as to whether to configure an additional action. In some embodiments, the determination may be made based on user input. For instance, the user may indicate that the user is finished configuring the conversational chat assistant, at which point the configuration information for the actions and the conversational chat assistant is stored in the database system at 1216.

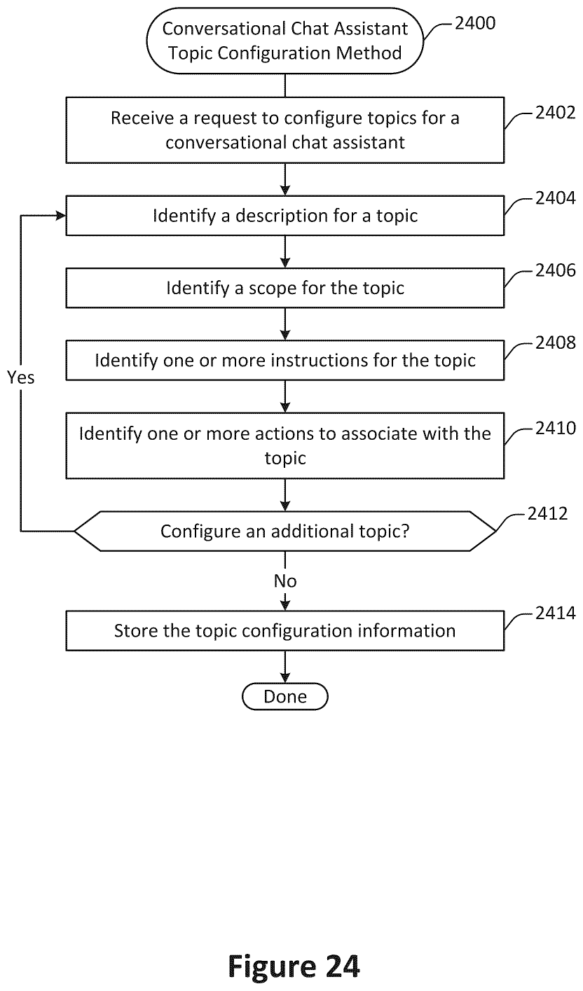

FIG. 24 illustrates a method 2400 of configuring a topic, performed in accordance with one or more embodiments. In some embodiments, the method 2400 may be used to define a topic based on one or more metadata entries, in a manner similar to the configuration of actions discussed with respect to the method 1200 shown in FIG. 12.

A request to configure one or more topics for a conversational chat assistant is received at 2402. In some embodiments, the request may be received at a conversational chat studio such as the conversational chat studio 112 shown in FIG. 2.

A description of a topic is identified at 2404. In some embodiments, the description of the topic may include information such as a name, a context, and/or any other characterization information. Some or all of the description information may be provided to a generative language model as part of an intent evaluation prompt completed by the generative language model to select a topic.

A scope for the topic is identified at 2406. In some embodiments, the scope may identify one or more products, services, customer organizations, industries, and/or other contexts in which the topic may be selected.

One or more instructions for the topic are identified at 2408. In some embodiments, the one or more instructions may include natural language provided to a generative language model for selecting and/or executing actions after a topic has been selected. For instance, the one or more instructions may be provided to the generative language model along with a set of actions that are selectable by the generative language model to fulfill the user's intent as reflected in natural language user input.

One or more actions to associate with the topic are identified at 2410. In some embodiments, the actions may be configured as discussed with respect to the method 1200 shown in FIG. 12, with respect to the metadata diagram 1300 shown in FIG. 13, and throughout the application.

According to various embodiments, some or all of the information identified as discussed with respect to the operations 2404-2410 may be identified based on user input. For instance, user input may be provided in text-based format or another format via the conversational chat studio 112. Alternatively, or additionally, some or all of the information identified as discussed with respect to the operations 2404-2410 may be identified by a generative language model. For instance, a generative language model may determine such information in response to text input provided by a user.

A determination is made at 2412 as to whether to configure an additional topic. In some embodiments, the determination may be made based on user input. Upon determining not to configure an additional topic, the topic configuration information is stored in the database system at 2414.

FIG. 13 illustrates a metadata diagram 1300 showing relationships between elements for configuring actions, provided in accordance with one or more embodiments. The metadata diagram 1300 includes the actions 1304, the building blocks 1306, a type registry 1306, inputs 1302, outputs 1304, code object definitions 1308, data object definitions 1310, and property types 1310.

As shown in FIG. 7, an action may be composed of one or more building blocks. Additionally, an action may optionally include one or more inputs 1302 and outputs 1304. Inputs 1302 and outputs 1304 may be registered in the type registry 1306 to facilitate the integration of actions into the operation of the computing services environment 130.

In some embodiments, an input or output to an action may correspond to a code object definition 1308. A code object definition may be a variable, class, or other object defined in code executable via the computing services environment 130.

In some embodiments, an input or output to an action may correspond to a data object definition 1310. A data object definition may define a data object, such as a database object, accessible via the computing services environment 130.

In some embodiments, an input or output to an action may correspond to a property type 1310. A property type 1310 may be a primitive such as text or a number.

FIG. 14 illustrates an example of markup code 1400 corresponding to actions, configured in accordance with one or more embodiments. Markup code such as the markup code 1400 may be used to define actions in terms of their relationships with other elements such as other actions, code blocks, data types, and the like.

For example, the class FlightFinder 1402 corresponds to an action for finding an airplane flight. The class FlightFinder 1402 includes FlightRequest 1414 and FlightResponse 1416 data values. The FlightFinder class 1402 also includes an invocable method findFlights 1404 that receives as input a FlightRequest object parameter 1406, which is a List. The FlightRequest object parameter 1406 corresponds to a FlightRequest object definition 1408. The FlightRequest object definition 1408 is a schema that defines the types of information that may be included in a FlightRequest object. Such information must include a “fromCity” and a “toCity”, which are not personally identifying information and which are both text data. The invocable method findFlights 1404 returns as output a FlightResponse list 1410 which corresponds to a FlightResponse object definition 1412. The FlightResponse object definition 1412 includes a flight identifier and a flight cost. The flight identifier is a text field, while the flight cost is a number. Both are also identified as not including personally identifiable information. Both are identified as being displayable and as being used by the planner, for instance to determine the next action to perform in an orchestration.

According to various embodiments, default actions may be provided in the system, specified as shown in FIG. 14. Additionally, a customer or partner organization may provide additional actions that may be integrated into flows performed based on interactions with a conversational chat interface.

FIG. 15 and FIG. 16 illustrate examples of user interfaces 1500 and 1600 for configuring and testing various elements of a conversational chat assistant, generated in accordance with one or more embodiments. For example, the user interfaces 1500 and 1600 may be generated in the course of providing access to the conversational chat studio 162 shown in FIG. 2. For instance, an administrator may use the user interfaces 1500 and 1600 to configure and test a conversational chat assistant by identifying the specific actions triggered based on test conversation provided via a test conversational chat interface.

At 1502, the user interface 1500 allows for the selection and creation of actions for a conversational chat assistant. The plan tracer 1504 illustrates the output of a test interaction with the conversational chat assistant. For instance, the conversational test interface 1504 includes a text element 1506 in which a user requested to “Update the amount of the opportunity to 70K”. The conversational chat assistant asks the user to clarify the record to update at 1508 by generating novel text via a generative language model. When the user specifies “Acme”, the conversational chat assistant notes that Acme corresponds to two different records and provides a selectable option at 1514. After the user specifies the record to update at 1514, the conversational chat assistant updates the record and provides a confirmation response at 1516.

The action implementation interface 1508 illustrates the actions performed by the conversational chat assistant in the course of the interaction. For instance, at 1520, the chat assistant executes an “Update Record” action that takes as input 1522 the text input provided by the user and returns output 1524 indicating the result of performing a database system update based on the input in which the amount of the opportunity record that is the focus of the conversation is updated to 70,000. At 1526, the next action generates the confirmation response based on an interaction with a large language model.

A similar flow is shown in the user interface 1600. A set of actions available for the conversational chat assistant is shown at 1602. A test conversation 1616 illustrates an interaction in which the conversational chat assistant has generated a draft email message 1618 based on natural language input received via the chat interface and information retrieved from the database system. The draft email message 1618 includes links 1620 to products based on one or more database records.

The plan tracer 1604 shows the actions performed as part of generating the interaction. As one example, the inventory check action 1604 may be used to call an external system to track the progress to view inventory levels at different warehouses. Each action may be associated with one or more inputs and one or more outputs. For example, the inventory check action 1604 is associated with inputs that include a list of product recommendations, one or more parameters, and one or more context variables. The parameters include a location name associated with the warehouses. The context variables include an account identifier that uniquely identifies the account for which inventory levels are sought. The outputs include a list of inventory check results. The different input and output values may be defined further based on markup, for instance markup that specifies additional characteristics of an input or output value.

As another example, the send email action 1606 may be used to send a pre-created email to a customer with data integrated from the customer relations management data stored in the database for the customer organization and/or data from one or more external sources. The send email action 1606 includes as an input a list of product recommendations, which may be determined based on an internal workflow. The send email action 1606 also includes a template identifying one or more member product recommendations which may be used to retrieve one or more product recommendations dynamically determined based on user input. The context variables include an account identifier that uniquely identifies the account for which the email is being created. The outputs include an email generated by executing the action.

### Recommended Action Configuration and Selection

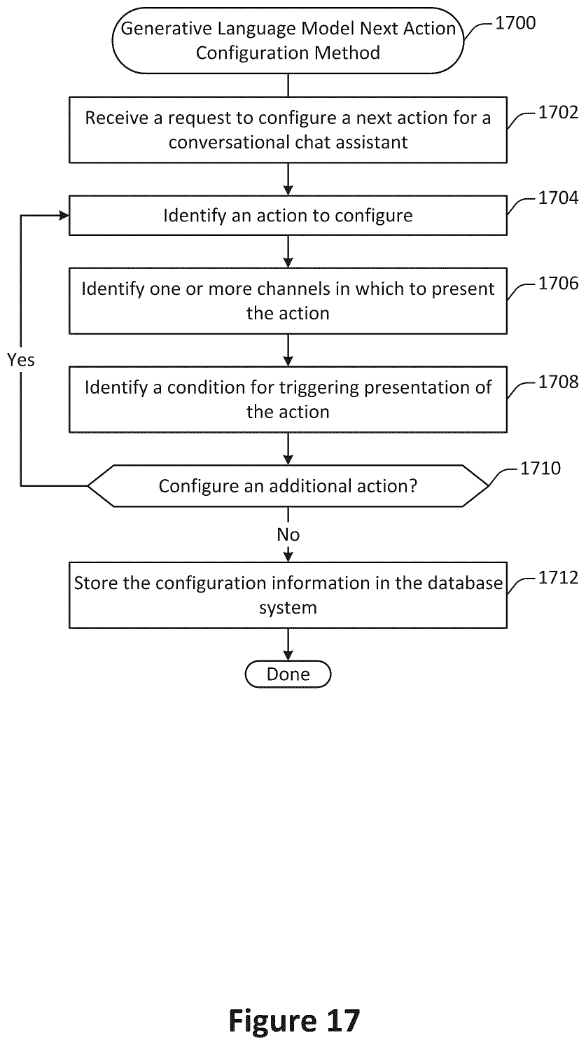

FIG. 17 illustrates a method 1700 for configuring a next action for a conversational chat assistant, performed in accordance with one or more embodiments. The method 1700 may be performed at the computing services environment 150 shown in FIG. 2. For instance, the method 1700 may be performed at a conversational chat studio 112 in communication with a client machine.

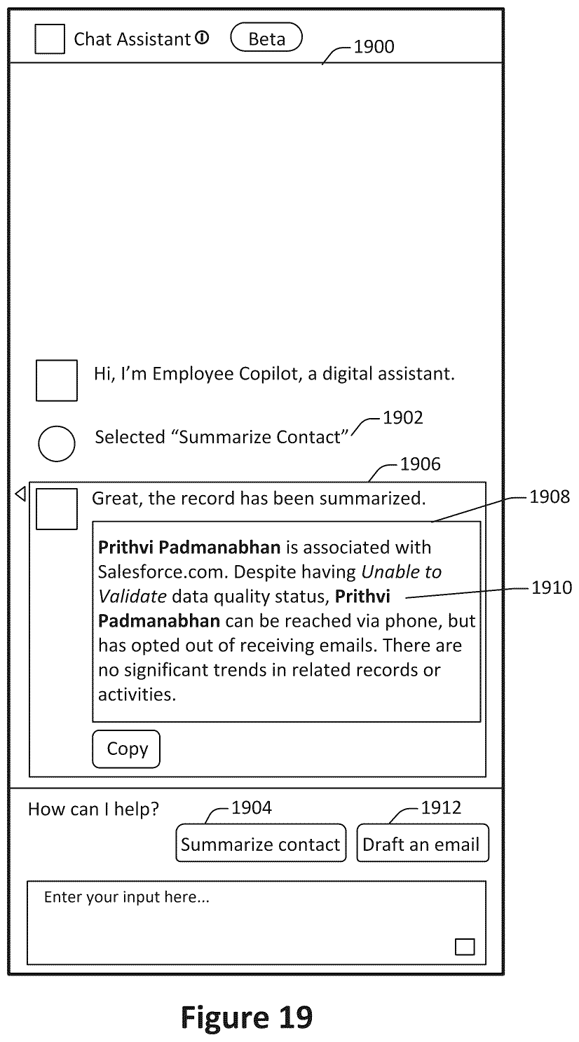

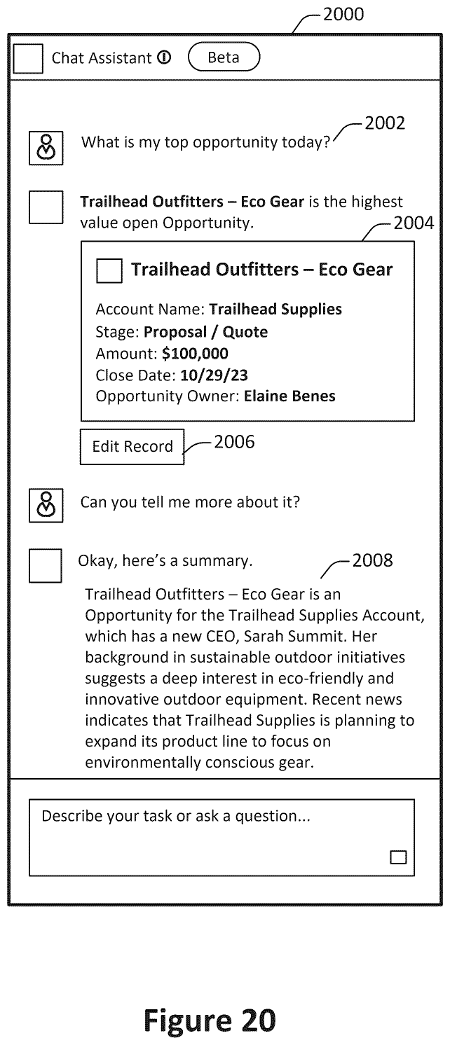

According to various embodiments, the method 1700 may be used to configure an action for recommendation in a conversational chat interface. For instance, as shown in FIG. 19, the completion of an action to summarize a record at 1906 triggers the automatic recommendation of an action to summarize a contact associated with the record at 1904 and an action to draft an email at 2012. As another example, in a different context, the presentation of a top opportunity at 1404 in FIG. 20 leads to the recommendation at 2006 of an action to edit the record that was presented.

In some embodiments, the method 1700 may be used to adapt a conversational chat assistant for use in different contexts, such as by different users or organizations. For instance, one user or organization may prefer to receive a recommendation to email a contact when a record summary is generated, while another user or organization may prefer to receive a recommendation to edit the record when a record summary is generated.

A request to configure a next action for a communication channel is received at 1702. In some embodiments, the request may be received from a client machine. For instance, an administrator associated with a client organization may configure a conversational chat assistant to automatically present a next action within a conversational chat interface when a triggering condition is met.

An action to configure is identified at 1704. In some embodiments, the action may be selected from within the user interface. For instance, the action may be selected from within a studio for configuring a conversational assistant.

One or more channels in which to present the action are identified at 1706. In some embodiments, a subset of available channels in which to present the action may be identified. Alternatively, the action may be presented on all channels through which interactions with the conversational chat assistant are conducted.

A condition for triggering presentation of the action is identified at 1708. According to various embodiments, any of a variety of triggering conditions may be specified. For example, one action may be triggered when another action is performed. As one example, when an action updating a database object is performed, the conversational chat assistant may automatically provide a recommendation to generate a summary of the database object. As another example, an action may be triggered when a value associated with a database object reaches a designated threshold. For instance, in an interaction with a conversational chat assistant that focuses on an opportunity object, an action to generate an email to a contact for the opportunity may be recommended if the value of the opportunity exceeds a designated amount.

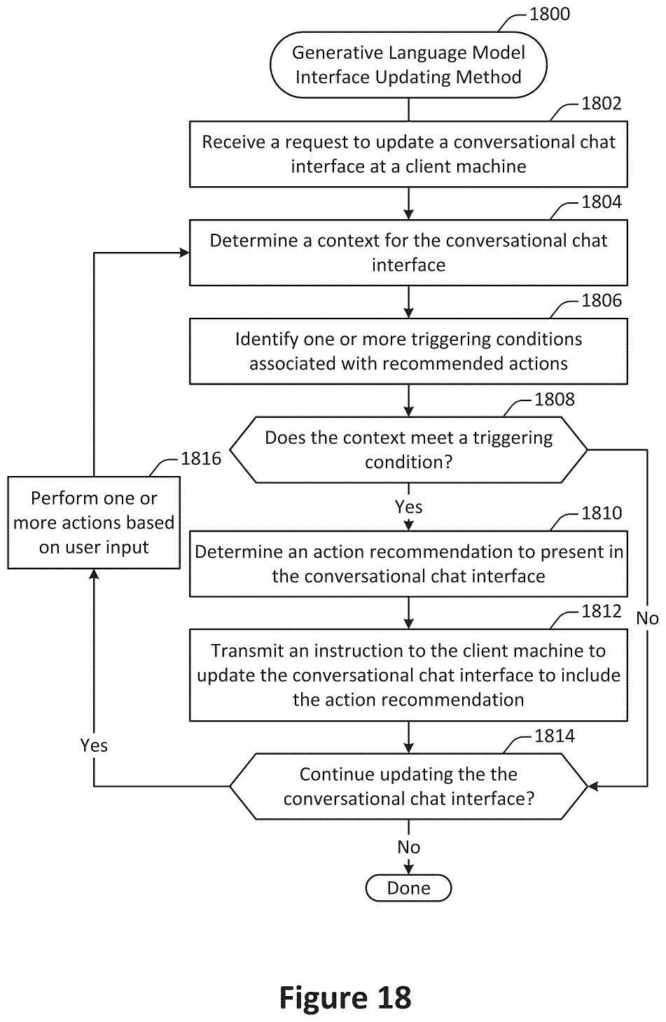

A determination is made at 1710 as to whether to configure an additional action. In some embodiments, the determination may be made based on user input. Upon determining not to configure an additional action, the configuration information is stored in the database system at 1712. The configuration information may be used to trigger recommendation of the configured actions or actions, as discussed in the method 1800 shown in FIG. 18.

In some embodiments, one or more of the operations shown in FIG. 17 may be performed automatically or dynamically by the system itself. For instance, the system may observe that for a particular organization or user, or across the system, a particular action is often selected when a particular condition is met. The system may then infer that the action should be recommended as a next action when the condition is met.

FIG. 18 illustrates a method 1800 for updating a conversational chat interface, performed in accordance with one or more embodiments. The method 1800 may be used to provide a recommended next action. For instance, the recommended next action may be determined based at least in part on the configuration information determined as discussed with respect to the method 1700 shown in FIG. 18.

A request to update a conversational chat interface is received at 1802. According to various embodiments, the conversational chat interface may be provided in the course of conducting an interaction between a conversational chat assistant operating within the computing services environment 150 and a user of a client machine authenticated to a user account at the computing services environment 150.

In some embodiments, the request may be received at 1802 when, for instance, the conversational chat assistant has determined or is determining a response to provide to the user via the conversational chat interface. For instance, the request may be received when the system is reporting the result of performing an action, providing text generated based on an interaction with a generative language model, or sending some other output to the client machine for presentation in the conversational chat interface.

In some embodiments, the request may be received when a user interface is generated. For instance, a user interface may be generated in a web application, a native application, a mobile application, a web browser plugin, or another type of user interface.

In some embodiments, the request may be received in the course of providing a response to a user. For example, as shown in FIG. 20, a natural language user request at 1402 to identify a top opportunity may be addressed with a response at 2004 identifying an opportunity satisfying the request. As another example, as shown in FIG. 19, a use request to summarize a contact at 1902 may yield a response at 1906 summarizing the record.

A context for the conversational chat interface is determined at 1804. According to various embodiments, the context may include any information that may be used to determine whether a triggering condition is met. For example, the context may include the text of any messages sent by a user to the conversational chat assistant or sent from the conversational chat assistant to the user. As another example, the context may include an indication of one or more actions that were performed in the course of the interaction.

According to various embodiments, the context for the conversational chat interface may include one or more of a variety of factors. For example, the context may include a customer organization for which the conversational chat interface is generated. As another example, the context may include a communication channel (e.g., a web application, a native application, a Slack channel, etc.) for which the conversational chat interface is generated. As still another example, the context may include data related to the generation of the conversational chat interface. For instance, the context may identify a database record such as a contact or account for a customer organization.

In some embodiments, the context may be determined based on the nature of the request received at 1802. For instance, the request may be generated when a user loads a customer relations management web application to access a contact record for a customer organization. The context may then be identified as the combination of the customer organization, the web application, and the contact record.

One or more triggering conditions associated with recommended actions are identified at 1806. In some embodiments, the one or more triggering conditions may include any conditions associated with an action recommendation as discussed with respect to the operation 1708 shown in FIG. 17. Such information may be retrieved from the database system.

In some embodiments, a default action may be presented. The default action may be determined by the customer organization or by the computing services environment provider. For example, a web application for presenting a contact record may be associated with a default action to summarize the contact record.

In some embodiments, a deterministic action may be presented. The deterministic action may be determined based on one or more operations performed in the context of the conversational chat interface. For instance, performing an action such as summarizing a record may lead to the presentation of an action for drafting an email that includes the summary.

In some embodiments, a non-deterministic action may be presented. The non-deterministic action may be determined based on a response provided by an artificial intelligence model such as a generative language model. For instance, a generative language model may be provided with a prompt that includes information such as the context determined 504, natural language input provided by the user, one or more prior actions performed by the user, and/or the identity of the user. As one example, the system may learn that one user typically requests to draft an email after summarizing a contact record, while another user typically asks to view opportunities related to the contact record. As another example, the system may learn that users would typically like to view opportunities related to the record when opportunities exist having a value above a designated threshold, while users would typically like to draft an email when no such opportunities exist.

A determination is made at 1808 as to whether the context determined at 1804 meets a triggering condition identified at 1806. Upon determining that the context meets a triggering condition, an action recommendation to present in the conversational chat interface is determined at 1810. In some embodiments, determining the action may involve identifying which action is associated with the triggering condition, such as the associated action identified at operation 1704 shown in FIG. 17.

An instruction to update the conversational chat interface to include the action recommendation is transmitted to the client machine at 1812. In some embodiments, the instruction may identify the action to present in the conversational chat interface. For instance, the action may be presented as a button, a drop-down menu, or another user interface affordance. The nature of the instruction may depend in significant part on the conversation channel in which the conversational chat interface is being presented.

A determination is made at 1814 as to whether to continue updating the conversational chat interface. In some embodiments, the determination may involve detecting one or more events generated by the client machine. Various types of user input may be received. For example, user input may include natural language text entered in the conversational chat interface. As another example, user input may include the detection of a button click corresponding with an action.

Upon determining to continue updating the conversational chat interface, one or more actions are performed at 1816 based on user input. In some embodiments, the conversational chat interface may continue to be updated so long as additional user input is received. Additional details regarding the types of user input that may be received and the types of actions that may be performed are discussed throughout the application.

In some embodiments, the method 1800 may be used to perform metadata-driven contextual interactions. For example, a user may first select an action to generate a summary of a record, and may then provide input to generate an email based on the summary. The system may generate novel text for both the summary and the email, and may dynamically determine new actions to present in the user interface for future interactions. In this example, the system is determining two different types of outputs: (1) novel text to include in the conversational chat interface, summary, and email, and (2) dynamically determined action buttons for performing new actions via the conversational chat interface. These different types of outputs are dynamically determined based on four different types of inputs: (1) the natural language input provided by the user, (2) the context in which the user input is provided (e.g., a web application), (3) the data the user is interacting with, and (4) metadata associated with the context (e.g., configuration parameters specific to the customer organization). Thus, the system can generate text and action recommendations that are highly customized to the user's context. For instance, when the user issues a natural language instruction to “Add some of our products to it”, the system can determine that “it” refers to the email that the system previously drafted, execute a workflow to determine product recommendations based on the content of the email, the user, the customer organization, and the records being accessed, and then call a generative language model to generate an updated email based on the retrieved product recommendations.

FIG. 19 illustrates a conversational chat interface 1900 provided in the context of a communication session with a conversational chat assistant, generated in accordance with one or more embodiments. The conversational chat interface 1900 may be provided in the context of an application used to access database objects stored in a database system accessible via the computing services environment 150. For instance, the conversational chat interface 1900 may be provided in the context of a web application provided via an application server.

User input is shown at 1902. The user input provided at 1902 is not natural language input, but rather indicates the selection of a recommended action 1904 provided via the conversational chat interface.

The user input 1902 triggers the generation of a response at 1906, which includes a record summary at 1908. In some implementations, the record summary may be determined based on an interaction with a generative language model in a context-dependent manner. For instance, the conversational chat interface 1900 may be accessed in the context of a contact record corresponding with Prithvi Padmanabhan.

In some embodiments, to summarize the record, a record summarization input prompt may be sent to a generative language model. The record summarization input prompt may include information selected from the record. The generative language model may then generate the record summary presented at 1908 and formatted in a manner specific to the communication channel.

In some embodiments, a record summary may include one or more links, such as the link 1910. A link included in the output may link to, for instance, another record within a database system accessible via the computing services environment 150.

FIG. 20 illustrates a conversational chat interface 2000 provided in the context of a communication session with a conversational chat assistant, generated in accordance with one or more embodiments. The conversational chat interface 2000 illustrates a conversational interaction between a user and the conversational chat assistant.

At 2002, the user provides natural language input including a request to identify the top opportunity. This natural language input causes the conversational chat assistant to first identify the user's intent, then to retrieve the appropriate information for the corresponding opportunity from the database system, and finally to format the information for presentation at 2004.

Included with the initial output is a button 2006 for triggering an action to edit the record. As discussed herein, such an action may be identified as a recommended next step depending on the context. For example, when a record is presented, a recommended next action may be to edit the presented record.

At 2008, the user provides natural language input stating “Can you tell me more about it?” This natural language input causes the conversational chat assistant to first identify the user's intent. From the context of the chat history, the conversational chat interface infers that “it” refers to the record that was recently returned. Further, a generative language model determines that the request indicates a desire to summarize the record, and indicates that a record summarization action should be performed. Next, the conversational chat assistant triggers the record summarization action to generate the summary at 2008, which is formatted for presentation in the conversational chat interface 2000 in accordance with one or more configuration parameters.

### User Interface Configuration

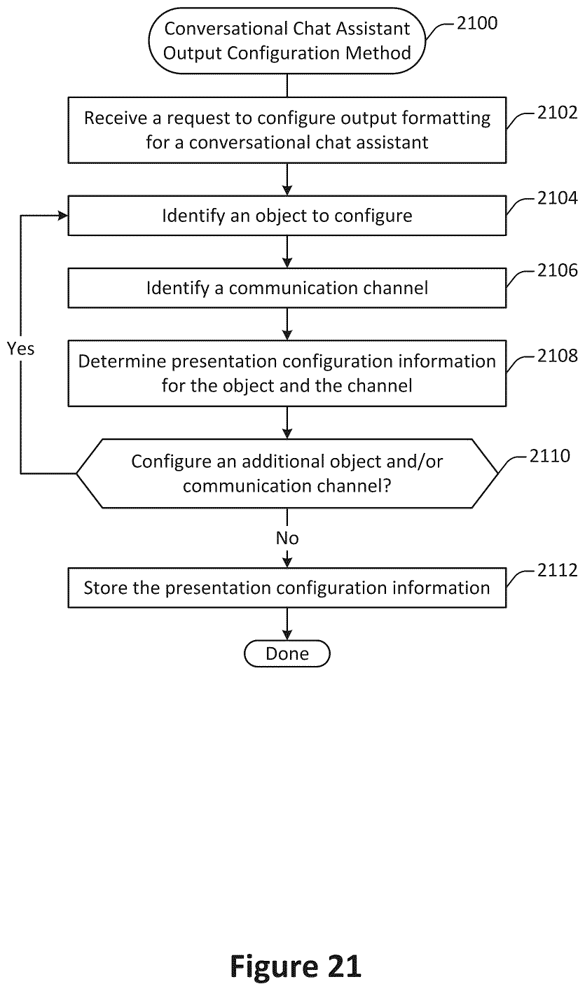

FIG. 21 illustrates a method 2100 for configuring a conversational chat interface for a conversational chat assistant, performed in accordance with one or more embodiments. The method 2100 may be performed at the computing services environment 150 shown in FIG. 1.

According to various embodiments, the method 2100 may be used to differentially configure how input and output of a conversational chat interface is displayed for different actions and communication channels. For instance, by default the input or output may be displayed as text or rich text. However, the input or output may be configured to display as a card, as an image, as a video, as formatted text, and/or as any suitable format. The input or output may also be configured to display differently in a native application, a web interface, a Slack interface, and/or in some other communication channel.

According to various embodiments, the conversational chat assistant may be configured in a manner specific to a customer organization of a computing services environment. In this way, different customer organizations may separately configure one or more conversational chat assistants to reflect the needs of the various organizations.

At 2102, a request is received to configure output formatting for a conversational chat assistant. In some embodiments, the request may be received in the context of configuring a conversational chat assistant via the conversational chat studio 202.

An object to configure is identified at 2104. In some embodiments, the object may be a representation of data that may be presented via the conversational chat interface. For instance, the object may be a database object, a list of database objects, a portion of text, or any other suitable type of information. The object may be identified by, for instance, user input.

A communication channel to configure is identified at 2106. In some embodiments, the communication channel may be selected by a user. The communication channel may be any communication channel through which communication with a user may be conducted. For instance, the communication channel may be a web application, an embedded chat interface, a messaging interface, a mobile application, or any other suitable channel.

Presentation configuration information for the object and the channel are determined at 2108. According to various embodiments, the presentation configuration information may include text formatting specific to the object and the channel. For instance, the presentation configuration information may include a representation of how a list of opportunity objects is to be presented in a mobile interface during interactions within the conversational chat assistant.

In some embodiments, the presentation configuration information may be determined based on user input. For instance, a user may select and/or provide presentation configuration information via the conversational chat studio 202.

A determination is made at 2110 as to whether to configure an additional object and/or communication channel. In some embodiments, the determination may be made based on user input. For instance, the user may indicate when configuration has been completed.

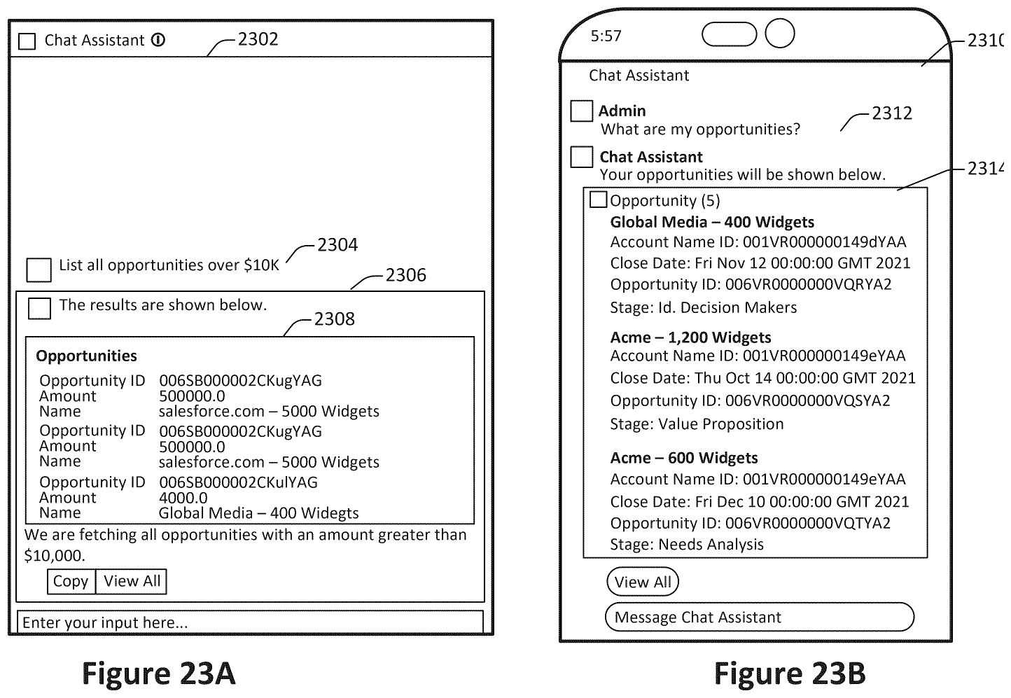

The presentation configuration information is stored at 2112. The stored presentation configuration information may then be used to format the presentation of information output via a conversational chat interface. Examples of such formatting are shown throughout the application, for instance in FIG. 23A and FIG. 23B.

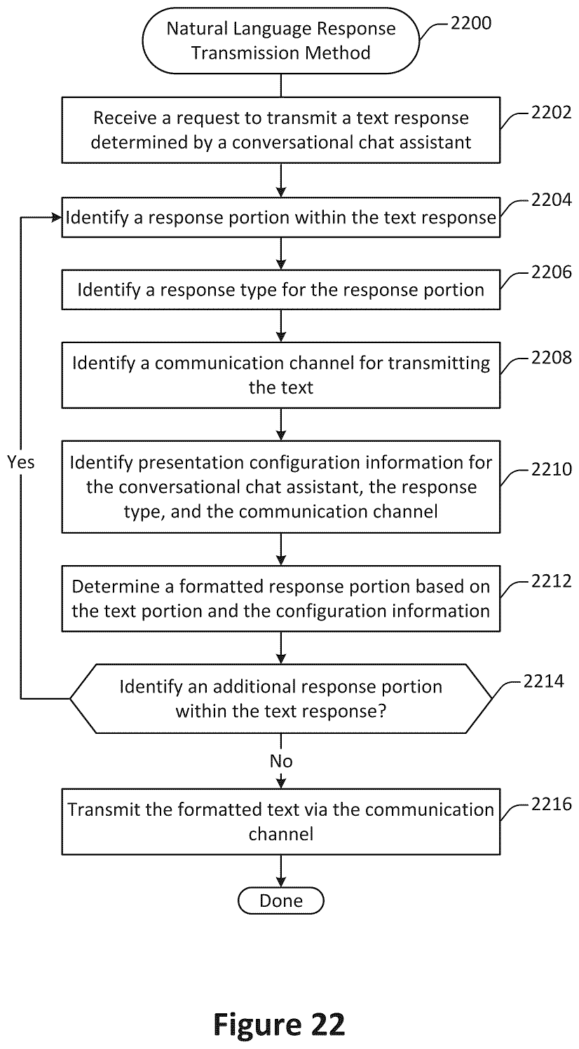

FIG. 22 illustrates a method 2200 for transmitting a natural language response generated by a conversational chat assistant, performed in accordance with one or more embodiments. The method 2200 may be performed at the computing services environment 150 shown in FIG. 1.

A request to transmit a text response determined by a conversational chat assistant is received at 2202. In some embodiments, the request may be received in the course of facilitating an interaction between an end user and the conversational chat assistant via a communication channel. For instance, the user may provide user input, in response to which the conversational chat assistant may generate a text response. The text response may be generated based on a prompt completion provided by a generative language model or may be generated in some other way, for instance via a predetermined text response template.

A response portion within the text response is identified at 2204. In some embodiments, a response portion may correspond to a type of output, such as information associated with a list of objects retrieved from a database system, a text message, a uniform resource locator, or any other type of information that can be transmitted via the communication channel.

The response type for the response portion is identified at 2206. In some embodiments, the response type may be specified via a tag or other indicator. For instance, a list may be identified via a tag such as “<list>”.

According to various embodiments, any of various response types may be supported. For instance, different database object types may be associated with different formatting requirements.

A communication channel for transmitting the text is identified at 2208. In some embodiments, the communication channel may be determined based on the interaction between the client machine and the computing services environment 150. For example, as discussed herein, such interactions may be conducted via a conversational chat interface in a website, native application, web application, or the like. As another example, such interactions may be conducted via a messaging service such as email, SMS, Slack, or Microsoft Teams.

Configuration information for the conversational chat assistant, the response type, and the communication channel is identified at 2210. According to various embodiments, such information may be determined as discussed with respect to the method 2100 shown in FIG. 21.

A formatted response portion is determined at 2212 based on the configuration information and the response portion. In some embodiments, determining the formatted response portion may involve applying metadata to the response portion to support its presentation at the client machine. Such information may be determined in a manner specific to the communication channel. For instance, in some communication channels the text formatting may be applied via HTML markup. However, other approaches may be employed in other communication channels.

A determination is made at 2214 as to whether to identify an additional response portion within the text response. In some embodiments, the determination may be made based on whether the text response includes additional response portions associated with presentation configuration information determined as discussed with respect to the method 2100 shown in FIG. 21. Upon determining not to identify an additional response portion, the formatted text is transmitted at 2216 via the communication channel.

FIGS. 23A and 23B illustrate configurable user interfaces, provided in accordance with one or more embodiments. As shown in FIG. 23A, a request in natural language at 2304 to “List all opportunities over $10K” triggers a response from the conversational chat assistant at 2306 listing information identifying database objects corresponding with those opportunities. The opportunities are listed in a user interface output portion 2308 in which each opportunity includes an identifier, an amount, and a name. The name may be selected to load a representation of the corresponding database object.

The interaction illustrated in FIG. 23A is conducted via a conversational chat interface presented in a web interface 2302. Accordingly, the user interface output portion 2308 is formatted in a manner specific to the communication channel. For instance, the opportunity name 2308 includes wide spacing between text elements and database objects.

As shown in FIG. 23B, a similar request in a different conversational chat interface may be handled differently. The interaction illustrated in FIG. 23B is conducted via a conversational chat interface presented in a mobile application 2310. A request received at 2312 to identify open opportunities triggers a response 2314 from the conversational chat assistant listing open opportunities. The open opportunities are formatted in a manner specific to the communication channel. For instance, the opportunities include close dates and stage information in addition to the other information included in FIG. 23A. Also, the opportunities are presented in a manner that includes different spacing and text formatting than shown in FIG. 23A.

As shown in FIG. 12A and FIG. 12B, a conversational chat assistant may be used to access information via the computing services environment 150 via various communication channels, and the experience reflected in such interactions may vary based on the communication channel. Moreover, the information returned may be specific to the context. For example, a request to access “my open opportunities” will return different opportunities depending on the user logged in to the interface. For instance, as between FIG. 23A and FIG. 23B, characteristics such as the formatting, spacing, and information for presented opportunities varies depending on the communication channel. Such configuration elements may be specific by, for instance, a customer organization accessing computing services via the computing services environment 150.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A computing services environment comprising:
a database system storing a plurality of database records for a plurality of client organizations accessing computing services via the computing services environment, the computing services including a conversational chat assistant;
an application server receiving natural language user input for the conversational chat assistant via the Internet;
a generative language model interface providing access to one or more generative language models;
an orchestration and planning service configured to analyze the natural language user input via a generative language model of the one or more generative language models to identify a plurality of actions to execute via the computing services environment to fulfill an intent expressed in the natural language user input, wherein the computing services environment is configured to execute the plurality of actions to determine a natural language response message; and
a communication interface configured to transmit the natural language response message to a client machine via the application server.

2. The computing services environment recited in claim 1, wherein identifying the plurality of actions comprises:
determining an intent identification input prompt that includes the natural language user input and one or more natural language instructions executable by the generative language model to identify the plurality of actions;
transmitting the intent identification input prompt to the generative language model for completion;
receiving an intent identification prompt completion from the generative language model; and
identifying the plurality of actions by parsing the intent identification prompt completion.

3. The computing services environment recited in claim 2, wherein the intent identification input prompt identifies a plurality of predetermined actions executable by the computing services environment, wherein the plurality of actions are a subset of the plurality of predetermined actions, and wherein the plurality of actions are identified in the intent identification prompt completion.

4. The computing services environment recited in claim 3, wherein the plurality of predetermined actions are each associated with a respective unique identifier and a respective action description in the intent identification input prompt, and wherein the plurality of actions are identified in the intent identification prompt completion via the respective unique identifiers.

5. The computing services environment recited in claim 2, wherein identifying the plurality of actions comprises:
determining a topic identification input prompt that includes the natural language user input and a second one or more natural language instructions executable by the generative language model to identify a topic based on the natural language user input;
transmitting the topic identification input prompt to the generative language model for completion;
receiving a topic identification input prompt completion from the generative language model; and
identifying a topic of a plurality of topics by parsing the intent identification prompt completion, wherein each of the plurality of topics corresponds with a respective topic-based subset of the plurality of actions.

6. The computing services environment recited in claim 5, wherein the intent identification input prompt identifies a plurality of predetermined actions executable by the computing services environment, wherein the plurality of actions are a subset of the plurality of predetermined actions, wherein the plurality of actions are identified in the intent identification prompt completion, and wherein the plurality of predetermined actions are those corresponding with the identified topic.

7. The computing services environment recited in claim 1, wherein the conversational chat assistant is one of a plurality of conversational chat assistants accessible via the computing services environment, and wherein the conversational chat assistant is specific to a client organization of the plurality of client organizations.

8. The computing services environment recited in claim 1, further comprising a conversational chat studio configured to customize the conversational chat assistant based on graphical user input provided via a graphical user interface.

9. The computing services environment recited in claim 1, further comprising a metadata framework for specifying information related to the conversational chat assistant and the plurality of actions, an action of the plurality of actions being defined via a definition that includes one or more inputs, one or more outputs, a description, and one or more operations performed via the computing services environment, wherein the inputs and outputs are defined based on respective metadata entries consistent with the metadata framework.

10. The computing services environment recited in claim 1, further comprising a trust layer, wherein the trust layer is configured to mask sensitive data included in an input prompt before the input prompt is transmitted to a generative language model for completion.

11. The computing services environment recited in claim 10, wherein masking the sensitive data includes replacing a text portion with a unique identifier, and wherein the trust layer is further configured to demask a prompt completion received from the generative language model by replacing the unique identifier with the text portion.

12. The computing services environment recited in claim 1, wherein the one or more generative language models includes a first generative language model hosted outside the computing services environment, wherein the one or more generative language models includes a second generative language model hosted outside of the computing services environment.

13. The computing services environment recited in claim 1, wherein an action of the plurality of actions comprises retrieving one or more database records from the database system, the one or more database records being associated with a client organization of the plurality of client organizations.

14. A method performed at a computing services environment, the method comprising:
storing in a database system a plurality of database records for a plurality of client organizations accessing computing services via the computing services environment, the computing services including a conversational chat assistant;
receiving natural language user input for the conversational chat assistant at an application server via the Internet;
analyzing the natural language user input at an orchestration and planning service configured via a generative language model accessible via the computing services environment to identify a plurality of actions to execute via the computing services environment to fulfill an intent expressed in the natural language user input, wherein the computing services environment is configured to execute the plurality of actions to determine a natural language response message; and
transmitting the natural language response message to a client machine through the application server via a communication interface.

15. The method recited in claim 14, wherein identifying the plurality of actions comprises:
determining an intent identification input prompt that includes the natural language user input and one or more natural language instructions executable by the generative language model to identify the plurality of actions;
transmitting the intent identification input prompt to the generative language model for completion;
receiving an intent identification prompt completion from the generative language model; and
identifying the plurality of actions by parsing the intent identification prompt completion.

16. The method recited in claim 15, wherein the intent identification input prompt identifies a plurality of predetermined actions executable by the computing services environment, wherein the plurality of actions are a subset of the plurality of predetermined actions, and wherein the plurality of actions are identified in the intent identification prompt completion.

17. The method recited in claim 16, wherein the plurality of predetermined actions are each associated with a respective unique identifier and a respective action description in the intent identification input prompt, and wherein the plurality of actions are identified in the intent identification prompt completion via the respective unique identifiers.

18. The method recited in claim 15, wherein identifying the plurality of actions comprises:
determining a topic identification input prompt that includes the natural language user input and a second one or more natural language instructions executable by the generative language model to identify a topic based on the natural language user input;
transmitting the topic identification input prompt to the generative language model for completion;
receiving a topic identification input prompt completion from the generative language model; and
identifying a topic of a plurality of topics by parsing the intent identification prompt completion, wherein each of the plurality of topics corresponds with a respective topic-based subset of the plurality of actions.

19. One or more non-transitory computer readable media having instructions stored thereon for executing a method at a computing services environment, the method comprising:
storing in a database system a plurality of database records for a plurality of client organizations accessing computing services via the computing services environment, the computing services including a conversational chat assistant;
receiving natural language user input for the conversational chat assistant at an application server via the Internet;
analyzing the natural language user input at an orchestration and planning service configured via a generative language model accessible via the computing services environment to identify a plurality of actions to execute via the computing services environment to fulfill an intent expressed in the natural language user input, wherein the computing services environment is configured to execute the plurality of actions to determine a natural language response message; and
transmitting the natural language response message to a client machine through the application server via a communication interface.

20. The one or more non-transitory computer readable media recited in claim 19, wherein identifying the plurality of actions comprises:
determining an intent identification input prompt that includes the natural language user input and one or more natural language instructions executable by the generative language model to identify the plurality of actions;
transmitting the intent identification input prompt to the generative language model for completion, wherein the intent identification input prompt identifies a plurality of predetermined actions executable by the computing services environment, wherein the plurality of actions are a subset of the plurality of predetermined actions, and wherein the plurality of actions are identified in the intent identification prompt completion, wherein the plurality of predetermined actions are each associated with a respective unique identifier and a respective action description in the intent identification input prompt, and wherein the plurality of actions are identified in the intent identification prompt completion via the respective unique identifiers;
receiving an intent identification prompt completion from the generative language model; and
identifying the plurality of actions by parsing the intent identification prompt completion.
